(19) United States
(12) Patent Application Publication
(10) Pub. No.: US 2008/0120359 A1
(43) Pub. Date: May 22, 2008

(54) Information distribution method, distribution apparatus, and node

(75) Inventor: Atsushi Murakami, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 11/979,611

(22) Filed: Nov. 6, 2007

(30) Foreign Application Priority Data
Nov. 17, 2006 (JP) 2006-311477

(51) Int. Cl. G06F 15/16

(52) U.S. Cl. 709/201

(57) ABSTRACT

A distribution apparatus distributes content catalog information to a plurality of nodes in an information distribution system. The plurality of nodes are capable of performing communication with each other via a network, and are divided into a plurality of groups in accordance with a predetermined grouping condition. The content catalog information includes attribute information of content data which can be obtained by each of the nodes. The apparatus comprises storing means for storing new content catalog information including attribute information of new content data which can be newly obtained by each of the nodes, and distributing means for distributing the new content catalog information to the nodes belonging to each of the groups at timings which vary among the groups divided according to the grouping condition.

### CROSS REFERENCE TO RELATED APPLICATION

The present application claims priority from Japanese Patent Application No. 2006-311477, which was filed on Nov. 17, 2006, the disclosure of which is herein incorporated by reference in its entirety.

### BACKGROUND OF THE INVENTION

1. Field of the Invention

The present invention relates to a peer-to-peer (P2P) content distribution system having a plurality of nodes capable of performing communication with each other via a network. More particularly, the invention relates to the technical field of a content distribution system or the like in which a plurality of pieces of content data are stored so as to be spread to a plurality of nodes.

2. Description of the Related Art

As a content distribution system of this kind, a system in which content data is disposed (stored) so as to be spread to a plurality of nodes is known. With the system, resistance to a failure and dispersibility of accesses is increased. The locations of content data stored so as to be spread can be efficiently retrieved using a distributed hash table (hereinbelow called DHT) as disclosed in, for example, Japanese Unexamined Patent Application Publication No. 2006-197400.

The DHT is stored in each of the nodes. In the DHT, node information (including IP addresses and port numbers) indicative of a plurality of nodes to which various messages are to be transferred is registered.

Each of the nodes has content catalog information including attribute information (for example, content name, genre, artist name, and the like) of content data stored to be spread. Based on the attribute information included in the content catalog information, a message (query) for retrieving (finding) the location of desired content data is transmitted to another node. The message is transferred via a plurality of relay nodes to the node managing the location of the content data in accordance with the DHT. Finally, node information can be obtained from the management node at which the message arrives. In such a manner, the node which transmits the message can send a request for the content data to the node storing the content data to be retrieved, and receive the content data.

When new content data is entered in the system and stored, new content catalog information including the attribute information of the content data has to be distributed to all of the nodes.

### SUMMARY OF THE INVENTION

When the new content catalog information is distributed to all of the nodes at once, however, many nodes try to obtain (download) the new content data whose attribute information is included in the new content catalog information, the messages (queries) are concentrated on the node which manages the location of the new content data. Further, requests for the new content data are concentrated on nodes storing the new content data. It is feared that the device load and the network load increase. As a result, waiting time causes dissatisfaction of the users. Particularly, in the beginning of distribution of new content catalog information, new content data written in the new content catalog information has just been released. It is considered that the number of nodes obtaining and storing the data is small, and the number of pieces of data stored is not enough for requests from a number of nodes.

The present invention has been achieved in view of the above problem. An object of the invention is to provide an information distribution method, a distribution apparatus, and a node realizing suppressed device load and network load against concentration of accesses even when new content catalog information is just distributed.

In order to solve the above problem, the invention according to claim 1 relates to a distribution apparatus for distributing content catalog information to a plurality of nodes in an information distribution system, the plurality of nodes capable of performing communication with each other via a network, and being divided into a plurality of groups in accordance with a predetermined grouping condition, and the content catalog information including attribute information of content data which can be obtained by each of the nodes,

the apparatus comprising:

storing means for storing new content catalog information including attribute information of new content data which can be newly obtained by each of the nodes; and

distributing means for distributing the new content catalog information to the nodes belonging to each of the groups at timings which vary among the groups divided according to the grouping condition.

### BRIEF DESCRIPTION OF THE DRAWINGS

FIG. 1 is a diagram showing an example of a connection mode of nodes in a content distribution system as an embodiment of the present invention.

FIGS. 2A to 2C are diagrams showing an example of a state where a routing table is generated.

FIGS. 3A to 3D are diagrams showing an example of the routing table.

FIG. 4 is a conceptual diagram showing an example of the flow of a published message transmitted from a content holding node, expressed in a node ID space of a DHT.

FIG. 5 is a conceptual diagram showing an example of display mode transition of a music catalog.

FIG. 6 shows an example of a routing table held by a node X as a catalog management node.

FIGS. 7A to 7D are diagrams schematically showing a catalog distribution message.

FIGS. 8A and 8B are diagrams showing a state where DHT multicast is performed.

FIGS. 9A and 9B are diagrams showing a state where the DHT multicast is performed.

FIGS. 10A and 10B are diagrams showing a state where the DHT multicast is performed.

FIGS. 11A to 11C are diagrams showing a state where the DHT multicast is performed.

FIG. 12 is a diagram showing an example of a schematic configuration of a node.

FIG. 13 is a flowchart showing a new content catalog information distributing process in the catalog management node.

FIG. 14 is a flowchart showing a new content catalog information receiving process.

FIGS. 15A to 15C are diagrams showing examples of the content of a grouping condition table.

FIG. 16 is a flowchart showing a new content catalog information distributing process in the catalog management node in the case where the value of the most significant digit in a node ID is used as an element of the grouping condition.

FIG. 17 is a flowchart showing the new content catalog information distributing process in a catalog management server.

### DETAILED DESCRIPTION OF THE PREFERRED EMBODIMENTS

Best modes for carrying out the present invention will now be described with reference to the drawings. The following embodiments relate to the case where the present invention is applied to a content distribution system using a DHT (Distributed Hash Table).

### 1. Configuration of Content Distribution System

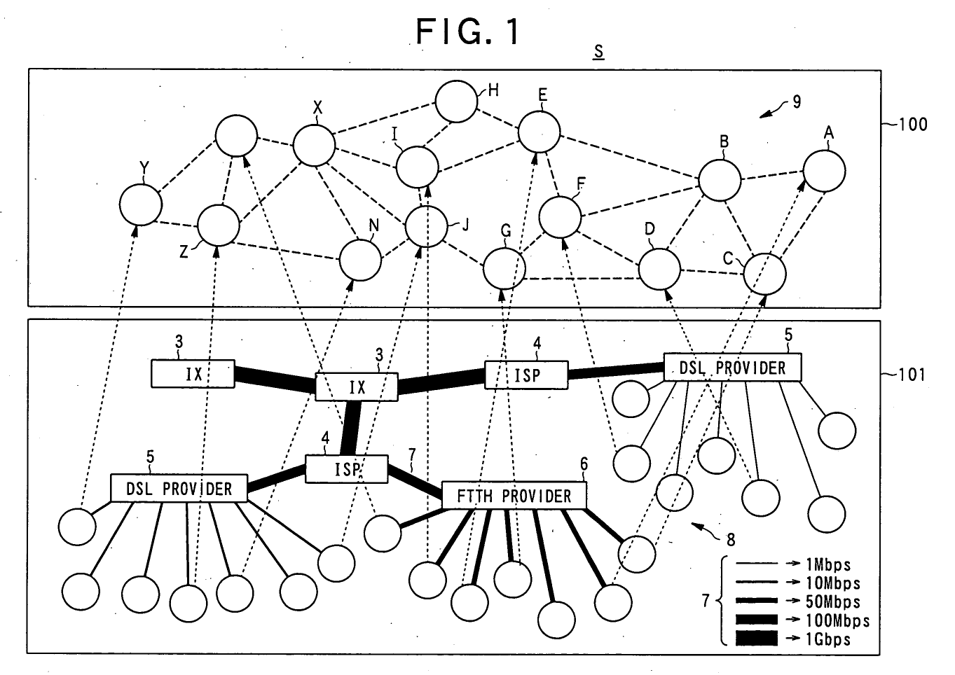

First, a schematic configuration and the like of a content distribution system as an example of an information distribution system will be described with reference to FIG. 1.

FIG. 1 is a diagram showing an example of a connection mode of nodes in a content distribution system as an embodiment.

As shown in a lower frame 101 in FIG. 1, a network 8 such as the Internet (network in the real world) is constructed by IXs (Internet exchanges) 3, ISPs (Internet Service Providers) 4, DSL (Digital Subscriber Line) providers (apparatuses) 5, FTTH (Fiber To The Home) providers (apparatuses) 6, communication lines (for example, telephone lines, optical cables, and the like) 7, and the like. Routers (not shown) for transferring a message (packet) are properly inserted in the networks (communication networks) 8 in the example of FIG. 1.

A content distribution system S is constructed by including a plurality of nodes A, B, C, . . . , X, Y, Z, . . . connected to each other via the networks 8. The content distribution system S is a peer-to-peer network system. IP (Internet Protocol) addresses as peculiar serial numbers and destination information are assigned to the nodes A, B, C, . . . , X, Y, Z, . . . The serial numbers and the IP addresses are unique to the plurality of nodes.

An algorithm using a distributed hash table (hereinbelow, called “DHT”) in the embodiment will now be described.

In the content distribution system S, each of the nodes has to know the IP address and the like of another node to/from which information is to be transmitted/received.

For example, in a system sharing content, in a simple method, all of nodes participating in the network 8 have to know IP addresses of all of the nodes participating in the network 8. However, when the number of terminals increases to tens of thousands or hundreds of thousands, it is not realistic to remember the IP addresses of all of the nodes. When the power supply of an arbitrary node is turned on or off, updating of the IP address of the arbitrary node stored in each becomes frequent, and it becomes difficult to perform updating in the operation.

A system is therefore devised in which a node stores only IP addresses of the minimum necessary nodes out of all of the nodes participated in the network 8 and, with respect to a node whose ID address is unknown (not stored), the information is transferred among the nodes.

As an example of such a system, an overlay network 9 as shown in an upper frame 100 in FIG. 1 is configured by an algorithm using the DHT. Specifically, the overlay network 9 denotes a network in which a virtual link formed by using the existing network 8 is constructed.

The embodiment is based on the overlay network 9 configured by an algorithm using the DHT. A node disposed on the overlay network 9 will be called a node participating in the overlay network 9. A node can participate in the overlay network 9 by sending a participation request to an arbitrary node already participating in the overlay network 9 (for example, a contact node which always participates in the overlay network 9).

Each node has a node ID as peculiar node identification information. The node ID is a hash value having a predetermined number of digits obtained by hashing the IP address or serial number with a common hash function (for example, SHA-1). With the node IDs, the nodes can be disposed so as to be uniformly spread in a single ID space. The node ID has to have the number of bits which is large enough to accommodate the maximum number of operating nodes. For example, when the number of bits is 128, 2̂128=340×10̂36 nodes can be operated.

When the IP addresses or serial numbers are different from each other, the probability that the node IDs obtained with the common hash function have the same value is extremely low. Since the hash function is known, the details will not be described.

### 1.1 Method of Generating Routing Table of DHT

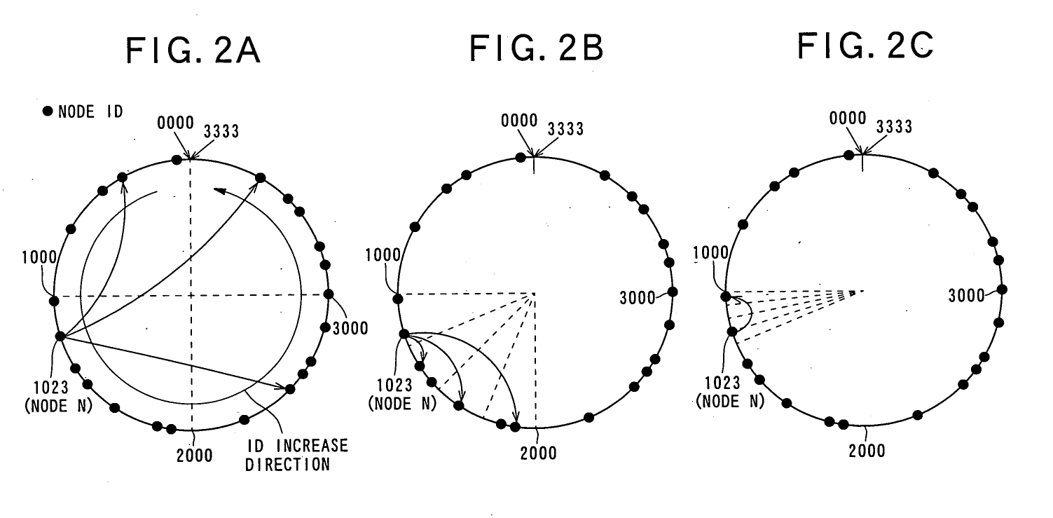

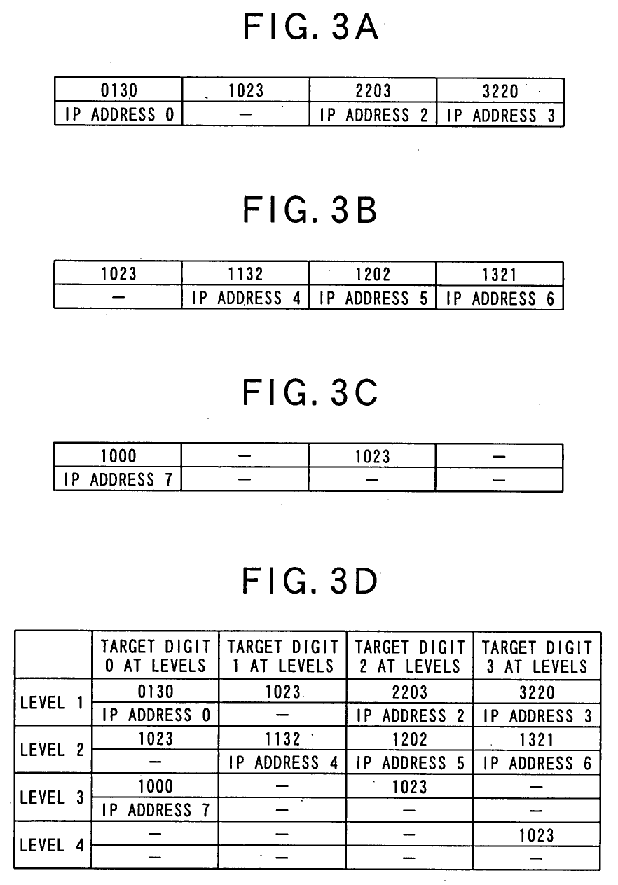

With reference to FIGS. 2A to 2C and FIGS. 3A to 3D, an example of a method of generating a routing table as the content of a DHT will be described.

FIGS. 2A to 2C are diagrams showing an example of a state where a routing table is generated. FIGS. 3A to 3D are diagrams showing an example of a routing table.

Since node IDs given to nodes are generated with the common hash function, it can be considered that the node IDs are spread more or less uniformly in a ring-shaped ID space as shown in FIGS. 2A to 2C. FIGS. 2A to 2C show a state where node IDs are given in eight bits. The painted circles show node IDs, and it is assumed that the value of the ID becomes larger in the counterclockwise direction.

First, as shown in FIG. 2A, the ID space is divided into some areas in accordance with a predetermined rule. In practice, the ID space is often divided into 16 areas. For simpler description, the ID space is divided into four areas, an ID is expressed in quaternary with a bit length of 8 bits. An example of setting the node ID of a node N as “1023” and generating a routing table of the node N will be described.

### Routing at Level 1

When the ID space is divided into four areas, the areas are expressed in quaternary as “0XXX”, “1XXX”, “2XXX”, and “3XXX” whose most significant digits are different from each other (X denotes an integer from 0 to 3, the definition will be the same also in the following). Since the node ID of the node N is “1023”, the node N exists in the left lower area “1XXX”.

The node N arbitrarily selects, as a representative node, a node existing in an area other than the area where the node N exists (that is, the area “1XXX”), and registers (stores) the IP address or the like of the node ID in a column in the table of level 1 (table entry). FIG. 3A shows an example of the table of level 1. Since the second column in the table of level 1 corresponds to the node N itself, it is unnecessary to register the IP address or the like.

### Routing at Level 2

Next, as shown in FIG. 2B, the area where the node N itself exists out of the four areas divided by the routing is further divided into four areas “10XX”, “11XX”, “12XX”, and “13XX”.

In a manner similar to the above, as a representative node, a node existing in an area other than the area where the node N exists is arbitrarily selected. The IP address or the like of the node ID is registered in a column in the table of level 2 (table entry). FIG. 3B shows an example of the table of level 2. Since the first column in the table of level 2 corresponds to the node N itself, it is unnecessary to register the IP address or the like.

### Routing at Level 3

As shown in FIG. 2C, the area where the node N itself exists out of the four areas divided by the routing is further divided into four areas “100X”, “101X”, “102X”, and “103X”. In a manner similar to the above, as a representative node, a node existing in an area other than the area where the node N exists is arbitrarily selected. The IP address or the like of the node ID is registered in a column in the table of level 3 (table entry). FIG. 3C shows an example of the table of level 3. Since the third column in the table of level 3 corresponds to the node N itself, it is unnecessary to register the IP address or the like. The second and fourth columns are blank for the reason that no nodes exist in the areas.

By generating the routing tables similar to the level 4 as shown in FIG. 3D, all of 8-bit IDs can be covered. As the level rises, blanks in the table become more conspicuous.

All of the nodes generate and have routing tables generated according to the method (rule) (the routing tables are generated, for example, when a node participates in the overlay network 9. However, the detailed description will not be given since the generation is not directly related to the present invention).

That is, each node stores a routing table specifying the IP address or the like of a node belonging to any of a plurality of areas divided as a level in association with the area and, further, specifying the IP address or the like of anode belonging to any of a plurality of areas each obtained by further dividing the area to which the node belongs as the next level.

The number of levels is determined according to the number of digits of the node ID, and the number of target digits at each level in FIG. 3D is determined in accordance with the value of the base. Concretely, when the number of digits is 16 and the base is 16, an ID is made of 64 bits, and the numerals (characters) of the target digits at level 16 are 0 to F. In the following description of a routing table, the part indicative of the number of target digits in each level will be also simply called a “row”.

### 1.2 Method of Storing and Finding Content Data

Next, a method of storing and finding content data which can be obtained in the content distribution system S will be described.

In the overlay network 9, various content data (such as movie, music, and the like) is stored so as to be spread to a plurality of nodes (in other words, content data is copied and replica as the copy information is stored so as to be spread).

For example, content data of a movie whose title is XXX is stored in nodes A and D. On the other hand, content data of a movie whose title is YYY is stored. In such a manner, the content data is stored so as to be spread to a plurality of nodes (hereinbelow, called “content holding nodes”).

To each of the content data, information such as the content name (title) and content ID (content identification information peculiar to the content) is added. The content ID is generated, for example, by hashing the content name+arbitrary numerical value (or a few bytes from the head of the content data) with the same hash function as that used for obtaining the node ID (the content ID is disposed in the same ID space as that of the node ID). Alternatively, the system administrator may assign a unique ID value (having the same bit length as that of the node ID) to each content. In this case, information is distributed to nodes in a state where the correspondence between the content name and the content ID is written in content catalog information which will be described later.

Index information is stored (in an index cache) and managed by a node that manages the location of the content data (hereinbelow, called “root node” or “root node of content (content ID)” or the like. The index information includes sets of the locations of the content data stored so as to be spared, that is, the IP addresses of nodes storing the content data and the content ID corresponding to the content data.

For example, the index information of content data of the movie whose title is XXX is managed by a node M as the root node of the content (content ID). The index information of content data of the movie whose title is YYY is managed by a node O as the root node of the content (content ID).

That is, the root node is assigned for each content, so that the load is distributed. Moreover, even in the case where the same content data (the same content ID) is stored in a plurality of content holding nodes, the index information of the content data can be managed by a single root node. For example, such a root node is determined to be a node having the node ID closest to the content ID (for example, a node having the largest number of upper digits matched with those of the content ID).

The node storing content data (content holding node) generates a publish (registration notification) message including the content ID of the content data and the IP address of the node itself in order to notify the root node of the fact that the content holding node stores the content data, and transmits the published message to the root node. In such a manner, the published message arrives at the root node by the DHT routing using the content ID as a key.

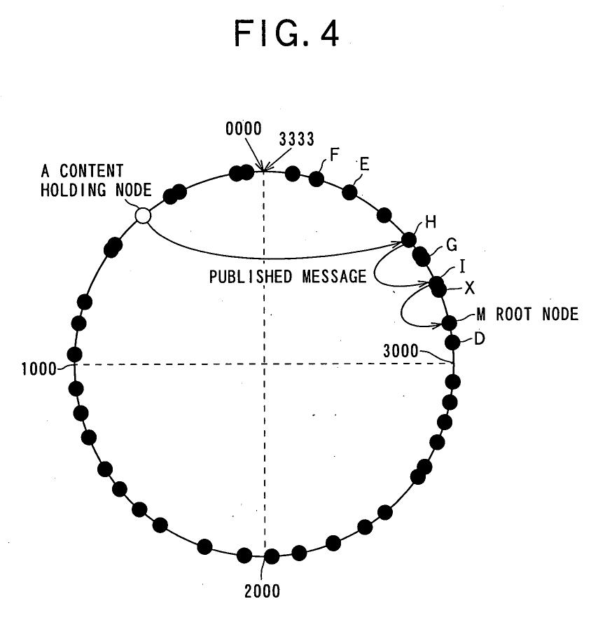

FIG. 4 is a conceptual diagram showing an example of the flow of the published message transmitted from the content holding node in the node ID space in the DHT.

In the example of FIG. 4, for example, the node A as a content holding node obtains the IP address or the like of the node H having the node ID closest to the content ID included in a published message (for example, the node ID having the largest number of upper digits matched with those of the content ID) with reference to the table of the level 1 of the DHT of itself. The node A transmits the published message to the IP address or the like.

The node H receives the published message, with reference to the table of the level 2 of the DHT of itself, obtains, for example, the IP address or the like of the node I having the node ID closest to the content ID included in the published message (for example, the node ID having the largest number of upper digits matched with those of the content ID), and transfers the published message to the IP address or the like.

The node I receives the published message, with reference to the table of the level 3 of the DHT of itself, obtains, for example, the IP address or the like of the node M having the node ID closest to the content ID included in the published message (for example, the node ID having the largest number of upper digits matched with those of the content ID), and transfers the published message to the IP address or the like.

The node M receives the published message, with reference to the table of the level 4 of the DHT of itself, recognizes that the node M is the node having the node ID closest to the content ID included in the published message (for example, the node ID having the largest number of upper digits matched with those of the content ID), that is, the node M itself is the root node of the content ID, and registers index information including the set of the IP address or the like included in the published message and the content ID (stores the index information into an index cache area).

The index information including the set of the IP address or the like included in the published message and the content ID is also registered (cached) in nodes existing in the transfer path extending from the content holding node to the root node (hereinbelow, called “relay nodes” which are the nodes H and I in the example of FIG. 4) (the relay nodes caching the index information will be called cache nodes).

In the case where the user of a node desires to obtain desired content data, the node desiring acquisition of the content data (hereinbelow, called “user node”) transmits a content location inquiring message including the content ID of the content data selected from the content catalog information by the user to another node in accordance with a routing table in the DHT of itself. Like the published message, the content location inquiring message is transferred via some relay nodes in accordance with the DHT routing using the content ID as a key and reaches the root node of the content ID. The user node obtains (receives) the index information of the content data, connects it to the content holding node that holds the content data on the basis of the IP address or the like, and can obtain (download) the content data. The user node can also obtain (receive) the IP address or the like from a relay node (cache node) caching the same index information as that in the root node before the content location inquiring message reaches the root node.

### 1.3 Details of Content Catalog Information

The details of the content catalog information will now be described.

In the content catalog information (also called a content list), attribute information of content data which can be obtained by each of nodes in the content distribution system S is described (registered) in association with each of content IDs.

Examples of the attribute information are the content name (movie title when the content is a movie, the title of a music piece when the content is a music piece, and a program title when the content is a broadcast program), the genre as an example of the kind (animation movie, action movie, horror movie, comedy movie, love story movie, or the like when the content is a movie, rock and roll, jazz, pops, classics, or the like when the content is music, and drama, sport, news, movie, music, animation, variety show, and the like when the content is a broadcast program), the artist name (the name of a singer, a group, or the like when the content is music), the performer name (a cast when the content is a movie or a broadcast program), the name of the director (when the content is a movie), and the like.

Such attribute information is an element used by the user to specify the desired content data and is also used as a search keyword as a search condition for retrieving the desired content data from a number of pieces of content data.

For example, when the user enters “jazz” as a search keyword, all of content data whose attribute information is “jazz” is retrieved, and the attribute information (for example, the content name, genre, and the like) of the retrieved content data is selectably presented to the user.

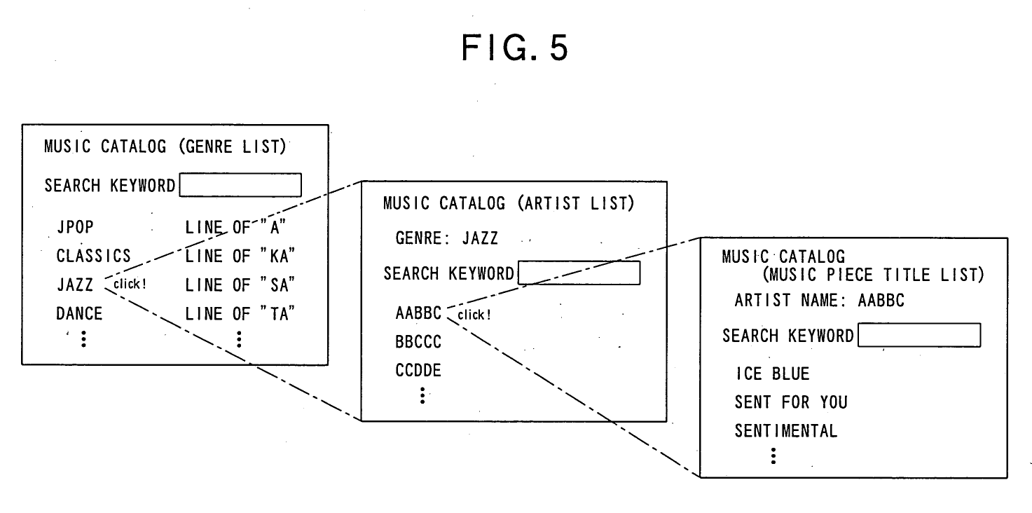

FIG. 5 is a conceptual diagram showing an example of the display mode transition of the music catalog at a node. In such a music catalog (or movie catalog), the above-described content catalog information is assembled. In the example of FIG. 5A, for example, jazz is entered as a search keyword in a displayed genre list and a search is made. As shown in FIG. 5B, a list of artist names corresponding to the jazz is displayed. For example, an artist “AABBC” is entered as a search keyword from the list of artist names and a search is made. As shown in FIG. 5C, a list of music piece titles corresponding to the artist (for example, sang or played by the artist) is displayed. When the user selects the title of a desired music piece using an input unit from the list of music piece titles, the content ID of the music piece data (an example of content data) is obtained and, as described above, a content location inquiring message including the content ID is transmitted to the root node. The content ID may not be described in the content catalog information. In this case, each of the nodes may generate a content ID by hashing “the content name included in the attribute information+an arbitrary numerical value” with the common hash function also used for hashing the node ID.

Such content catalog information is managed by, for example, a node managed by the system administrator or the like (hereinbelow, called “catalog managing node” (an example of the distribution system)) or a catalog management server (an example of the distribution system).

When new content data (specifically, new content data which can be newly obtained by a node) is loaded (stored for the first time) in a node existing in the content distribution system S, new content catalog information in which the attribute information of the new content data is registered is generated and distributed to all of the nodes participating in the overlay network 9. As described above, the content data once loaded is obtained from the content holding node and its replicas are stored.

### 1.4 Method of Distributing Content Catalog Information

The newly generated content catalog information may be distributed to all of nodes participating in the overlay network 9 from one or more catalog distribution server(s) (in this case, the catalog management server stores the IP addresses of nodes to which information is distributed). By multicast using the DHT (hereinbelow, called “DHT multicast”), the new content catalog information can be distributed more efficiently to all of nodes participating in the overlay network 9.

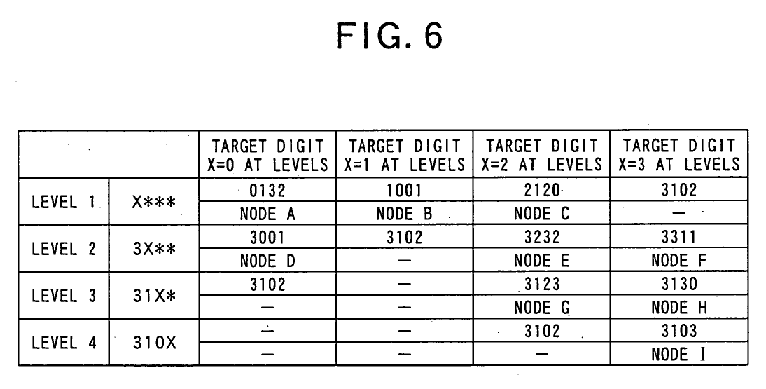

The method of distributing the content catalog information by the DHT multicast will be described with reference to FIG. 6 to FIGS. 11A and 11B.

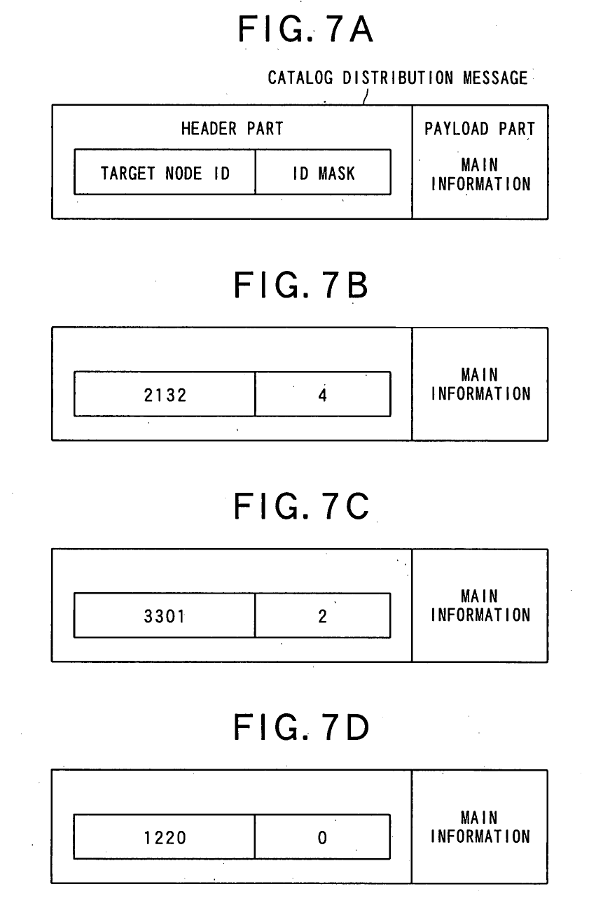

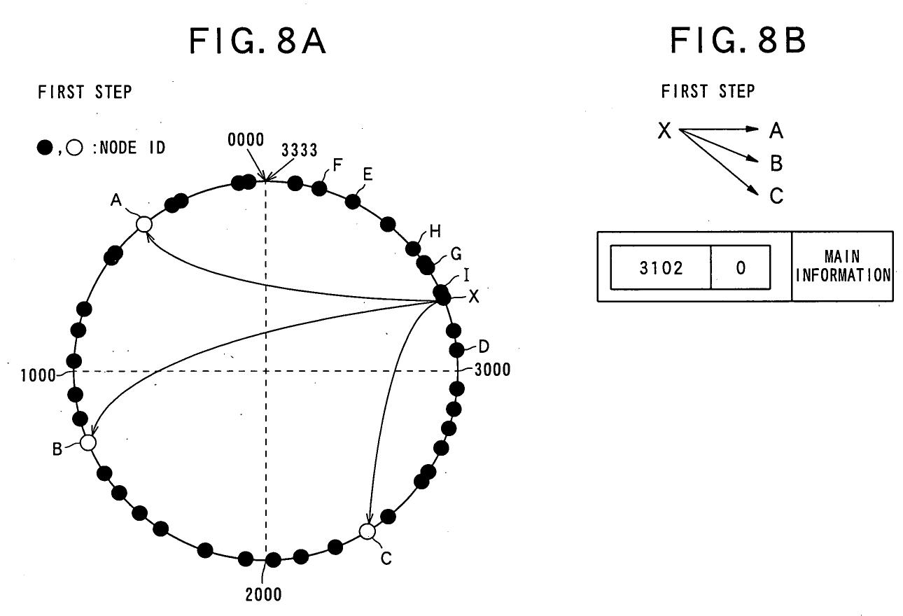

FIG. 6 shows an example of a routing table held by a node X as a catalog management node. FIGS. 7A to 7D are diagrams schematically showing a catalog distribution message. FIGS. 8A and 8B to FIGS. 11A and 11B are diagrams showing states where the DHT multicast is performed.

It is assumed that the node X holds a routing table as shown in FIG. 6, and node IDs (in four digits in base 4), the IP addresses, or the like of any of the nodes A to I are stored in the boxes corresponding to the areas of levels 1 to 4 in the routing table.

The catalog distribution message is formed as a packet constructed by a header part and a payload part as shown in FIG. 7A. The header part includes a target node ID, an ID mask, an IP address or the like (not shown) of the node corresponding to the target node ID. The payload part includes main information having the new content catalog information and the like.

The relation between the target node ID and the ID mask will be described specifically.

The target node ID has the same number of digits as that of the node ID (in the example of FIG. 6, four digits in base 4) and is used to set a node as a destination target. According to the value of the ID mask, for example, the node ID of a node from which the catalog distribution message is transmitted or a node to which the catalog distribution message is transferred, or the node ID of a node to which the catalog distribution message is transmitted is set.

The ID mask is used to designate the number of significant digits of the target node ID. According to the number of significant digits, a node ID whose upper digits by the number of significant digits matching those of the target node ID is displayed. Concretely, the ID mask (the value of the ID mask) is an integer equal to or larger than zero and equal to or less than the maximum number of digits of the node ID. For example, when the node ID has four digits in base 4, the ID mask has the integer from 0 to 4.

For example, as shown in FIG. 7B, when the target node ID is “2132” and the value of the ID mask is “4”, all of the “four” digits of the target node ID are valid, and only a node whose node ID is “2132” is the target to which the catalog distribution message is to be transmitted.

When the target node ID is “3301” and the value of the ID mask is “2” as shown in FIG. 7C, the upper “two” digits in the target node ID (the node ID “33**”) are valid, and all of nodes on the routing table, having upper two digits of “33” are targets to which the catalog distribution message is to be transmitted.

Further, when the target node ID is “1220” and the value of the ID mask is “0” as shown in FIG. 7D, no (“0”) upper digit in the target node ID is valid, that is, each digit may have any value (consequently, the target node ID may have any value). All of the nodes on the routing table are targets to which the catalog distribution message is to be transmitted.

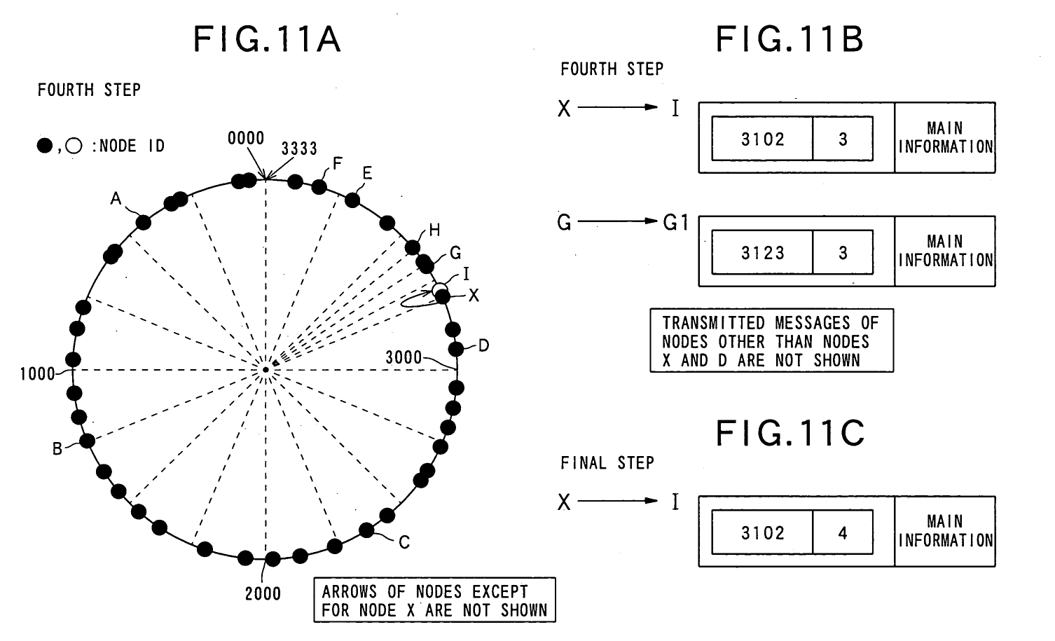

In the case where the node ID has four digits in base 4, the DHT multicast of the catalog distribution message transmitted from the node X as the catalog management node is performed in the first to four steps as shown in FIGS. 8A and BB to FIGS. 11A and 11B.

### First Step

First, the node X generates a catalog distribution message including the header part and the payload part by setting the target node ID as “3102” and setting the ID mask as “0” in the header part. As shown in FIGS. 7A and 7B, with reference to the routing table shown in FIG. 6, the node X transmits the catalog distribution message to representative nodes (nodes A, B, and C) registered in the boxes in the table of the level “1” obtained by adding “1” to the ID mask “0” (that is, belonging to the areas).

### Second Step

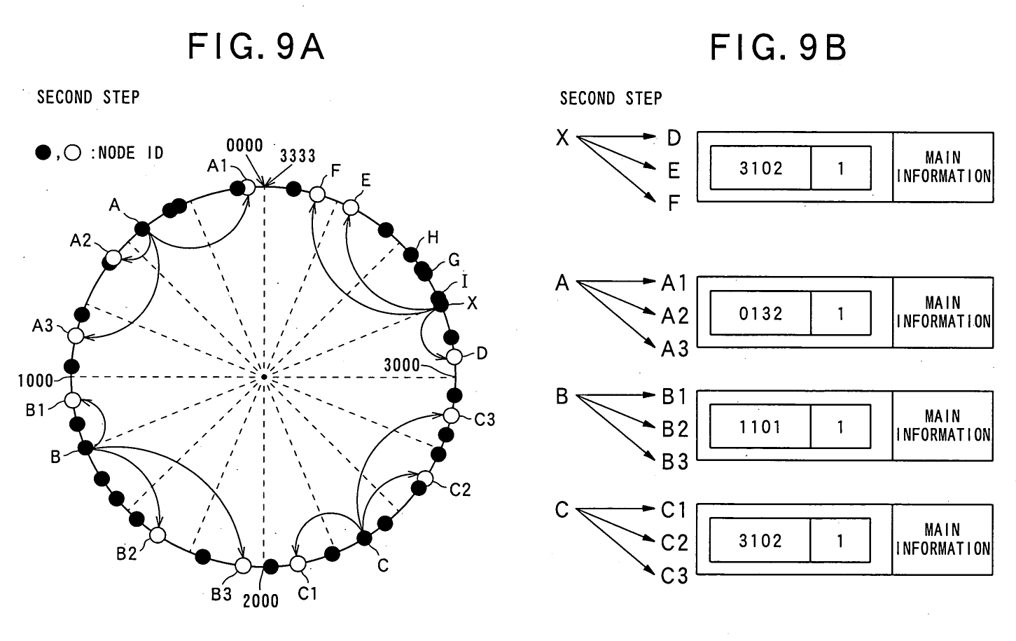

Next, the node X generates a catalog distribution message obtained by converting the ID mask “0” in the header part in the catalog distribution message to “1”. Since the target node ID is the node ID of the node X itself, it is not changed. With reference to the routing table shown in FIG. 6, the node X transmits the catalog distribution message to nodes (nodes D, E, and F) registered in the boxes in the table of the level “2” obtained by adding “1” to the ID mask “1” as shown in the upper right area in the node ID space of FIG. 9A and FIG. 9B.

On the other hand, the node A that receives the catalog distribution message (the catalog distribution message to the area to which the node A belongs) from the node X in the first step generates a catalog distribution message obtained by converting the ID mask “0” in the header part of the catalog distribution message to “1” and converting the target node ID “3102” to the node ID “0132” of itself.

With reference to a not-shown routing table of the node A itself, the node A transmits the catalog distribution table to nodes (nodes A1, A2, and A3) registered in the boxes in the table of the level “2” obtained by adding “1” to the ID mask “1” as shown in the upper left area in the node ID space of FIG. 9A and FIG. 9B.

That is, when the area “0XXX” to which the node A belongs is further divided to a plurality of areas (“00XX”, “01XX”, “02XX”, and “03XX”), the node A determines (representative) nodes (nodes A1, A2, and A3) belonging to the divided areas and transmits the received catalog distribution message to all of the determined nodes (nodes A1, A2, and A3) (in the following, the operation is similarly performed).

Similarly, as shown in the lower left and right areas in the node ID space of FIG. 9A and FIG. 9B, in the first step, the nodes B and C that receive the catalog distribution message from the node X generate catalog distribution messages by setting the ID mask “1” and setting the node IDs of themselves as the target node ID and transmit the generated catalog distribution messages to nodes registered in the boxes in the table at the level 2 (the nodes B1, B2, and B3 and the nodes C1, C2, and C3) with reference to the routing tables of themselves.

### Third Step

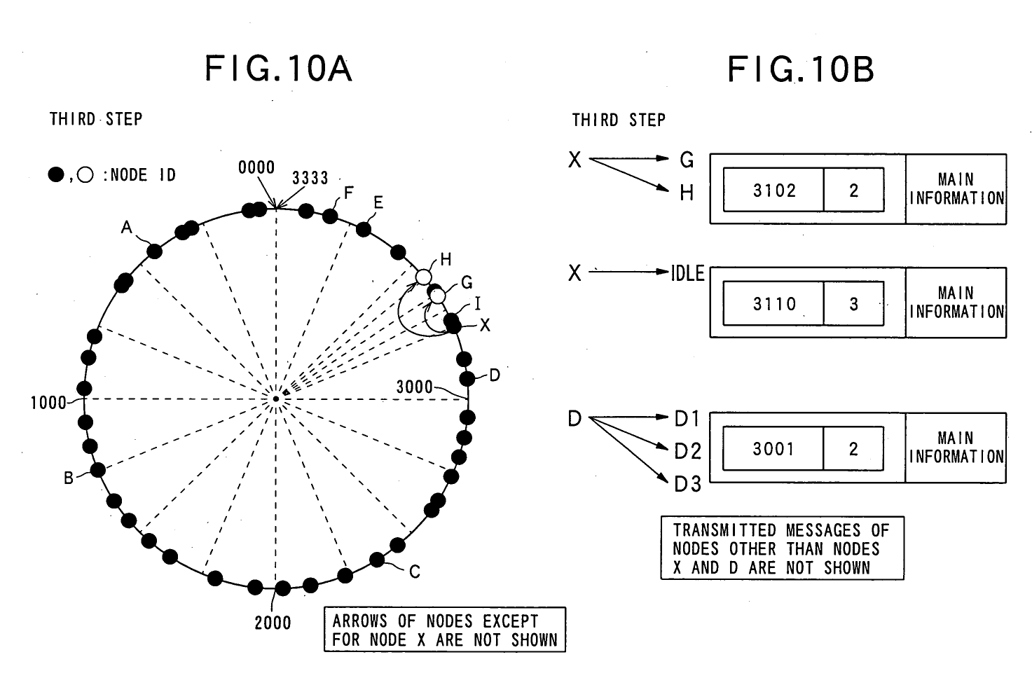

The node X generates a catalog distribution message obtained by converting the ID mask “1” in the header part of the catalog distribution message to “2”. In a manner similar to the above, the target node ID is not changed. Referring to the routing table shown in FIG. 6, the node X transmits the catalog distribution messages to nodes (nodes G and H) registered in the boxes in the table at the level “3” obtained by adding “1” to the ID mask “2” as shown in the upper right area in the node ID space of FIG. 10A and FIG. 10B.

In the second step, the node D which receives the catalog distribution message from the node X generates a catalog distribution message by converting the ID mask “1” in the header part of the catalog distribution message to “2” and converting the target node ID “3102” to the node ID “3001” of the node D itself. Referring to the routing table of itself, the node D transmits the catalog distribution message to the nodes (nodes D1, D2, and D3) registered in the boxes in the table at the level “3” obtained by adding “1” to the ID mask “2” as shown in FIG. 10B.

Similarly, although not shown, in the second step, each of the nodes E, F, A1, A2, A3, B1, B2, B3, C1, C2, and C3 which receive the catalog distribution message generates a catalog distribution message by setting the ID mask as “2” and setting the node ID of itself as the target node ID with reference to a routing table of itself, and transmits the generated catalog distribution message to a node (not shown) registered in the boxes in the table at the level 3.

### Fourth Step

The node X generates a catalog distribution message obtained by converting the ID mask “2” in the header part in the catalog distribution message to “3”. In a manner similar to the above, the target node ID is not changed. With reference to the routing table shown in FIG. 6, the node X transmits the catalog distribution message to the node I registered in a box in the table at the level “4” obtained by adding “1” to the ID mask “3” as shown in the upper right area in the node ID space of FIG. 11A and FIG. 11B.

In the third step, the node G which receives the catalog distribution message from the node X generates a catalog distribution message by converting the ID mask “2” in the header part of the catalog distribution message to “3” and converting the target node ID “3102” to the node ID “3123” of the node G itself. Referring to the routing table of itself, the node G transmits the catalog distribution message to the node G1 registered in a box in the table at the level “4” obtained by adding “1” to the ID mask “3” as shown in FIG. 11B.

Similarly, although not shown, in the third step, each of the nodes which receive the catalog distribution message generates a catalog distribution message by setting the ID mask as “3” and setting the node ID of itself as the target node ID with reference to a routing table of itself, and transmits the generated catalog distribution message to a node (not shown) registered in the boxes in the table at the level 4.

### Final Step

Finally, the node X generates a catalog distribution message obtained by converting the ID mask “3” to “4” in the header part in the catalog distribution message. The node X recognizes that the catalog distribution message is addressed to itself (the node X itself) on the basis of the target node ID and the ID mask, and finishes the transmitting process.

Each of the nodes which receive the catalog distribution message in the fourth step also generates a catalog distribution message obtained by converting the ID mask “3” in the header part of the catalog distribution message to “4”. The node recognizes that the catalog distribution message is addressed to itself (the node itself) on the basis of the target node ID and the ID mask, and finishes the transmitting process.

As described above, new content catalog information is distributed from the node X as the catalog management node to all of nodes participating in the overlay network 9 by the DHT multicast, and each of the nodes can store the content catalog information.

### 1.5 Time-Division Distribution of Content Catalog Information

When new content catalog information is distributed to all of nodes at once as described above, to obtain (download) the new content data whose attribute information is registered in the new content catalog information, requests for index information of the new content data are concentrated in the root node (that is, content location inquiring messages including the content ID of the new content data are concentrated) and, further, requests for the new content data are concentrated on the content holding node. It is feared that the load on the nodes and the load on the network increase. As a result, waiting time causes dissatisfaction of the users. Particularly, in the beginning of distribution of new content catalog information, new content data registered in the new content catalog information has just been released. It is considered that the number of nodes obtaining and storing the data is small, and the number of pieces of data stored is not enough for requests from a number of nodes.

In the embodiment, the plurality of nodes are divided into a plurality of groups according to a predetermined grouping condition. At timings which are different among the groups (in other words, at different times among the groups), the new content catalog information is distributed to nodes belonging to the different groups.

In the case of distributing new content catalog information by the DHT multicast from the catalog management node, as described above, the catalog distribution message is received by all of the nodes participating in the overlay network 9. Consequently, to enable only nodes belonging to a specific group as a target of distribution to use the new content catalog information, condition information indicative of the grouping condition corresponding to a group to which the new content catalog information is to be distributed is added to the new content catalog information and the catalog distribution message is distributed. Each of nodes which receive the new content catalog information determines whether the grouping condition indicated as the condition information added to the new content catalog information is satisfied or not. When the grouping condition is satisfied, the node stores the received new content catalog information so as to be able to be used. When the grouping condition is not satisfied, the new content catalog information is discarded.

On the other hand, in the case of distributing new content catalog information from the catalog management server, the catalog management server recognizes information necessary for grouping all of nodes participating in the overlay network 9 (for example, by obtaining it from the content node or the like). On the basis of the recognized information, the catalog management server groups the nodes, and distributes the new content catalog information to nodes belonging to a specific group to which the information is to be distributed. In this case, it is unnecessary to add the condition information to new content catalog information.

Elements of the grouping conditions include the value of a predetermined digit in a node ID, a node disposing area, a service provider of connection of a node to the network 8, the number of hops to a node, reproduction time (preview time) of content data in a node or the number of reproduction times (preview times), and current passage time in a node.

In the case where the value of a predetermined digit in a node ID is used as an element of the grouping condition, for example, nodes can be divided to a group of nodes whose least significant digit (the most significant digit or the like) is “1”, a group of nodes whose least significant digit is “2”, . . . When a node ID is expressed in hexadecimal, the value of a predetermined digit is expressed in any of 0 to F, so that nodes can be divided into 16 groups. The catalog management node or the catalog management server distributes new content catalog information to all of nodes belonging to a group in which the least significant digit of a node ID is “1” (in the case of distribution by the DHT multicast, condition information indicative of the grouping condition (for example, the least significant digit of a node ID is “1”) is added to new content catalog information). After lapse of preset time (for example, 24 hours) since the distribution, the new content catalog information is distributed to nodes belonging to a group in which the least significant digit in a node ID is “2” (for example, in the case of dividing nodes into 16 groups, the information is distributed 16 times at different times).

In the case where the node disposing area is used as an element of the grouping condition, for example, nodes can be divided to a group of nodes whose disposing area is Minato-ward in Tokyo, a group of nodes whose disposing area is Shibuya-ward in Tokyo, . . . Such disposing area can be determined on the basis of, for example, a postal code or telephone number which is set in each of nodes. The catalog management node or the catalog management server distributes new content catalog information to all of nodes belonging to the group in which the disposing area is Shibuya-ward in Tokyo (in the case of distribution by the DHT multicast, condition information indicative of the grouping condition (for example, the disposing area is Shibuya-ward in Tokyo) is added to new content catalog information). After lapse of preset time (for example, 24 hours) since the distribution, the new content catalog information is distributed to nodes belonging to a group in which the disposing area is Minato-ward in Tokyo.

In the case of using a service provider of connection of a node to the network 8 (for example, an Internet connection service provider (hereinbelow, called “ISP”) as an element of a grouping condition, for example, nodes can be grouped on the basis of AS (Autonomous System) numbers. The AS denotes a lump of networks having a single (common) operation policy as a component of the Internet (also called an autonomous system). The Internet can be regarded as a collection of ASs. For example, ASs are divided every network constructed by an ISP. Unconditional AS numbers different from each other are assigned in the range of, for example, 1 to 65535. When a node obtains the number of an AS to which the node belongs, the node can use a method of accessing the “who is” database of the IRR (Internet Routing Registry) or JPNIC (Japan Network Information Center) (the AS number can be known from the IP address), or a method that the user obtains the AS number of a subscribed line from the ISP in advance and preliminarily enters the value to a node. The catalog management node or the catalog management server distributes new content catalog information to all of nodes belonging to a group whose AS number is “2345” (in the case of distribution by the DHT multicast, condition information indicative of a grouping condition (for example, the AS number is “2345”) is added to the new content catalog information). After lapse of preset time (for example, 24 hours) since the distribution, the new content catalog information is distributed to nodes belonging to a group whose AS number is “3456”.

In the case of using the number of hops to a node as an element of the grouping condition, for example, nodes can be divided to a group of nodes each having the number of hops from the catalog management server (the number of relay devices such as routers a packet passed through) in a range of “1 to 10”, a group of nodes each having the number of hops in a range of “11 to 20”, . . . A packet for distributing new content catalog information includes TTL (Time To Live) indicative of a reachable range. The TTL is expressed by an integer value up to the maximum value “255”. Each time a catalog distribution message (packet) passes through a router or the like, the TTL decreases by one. When the TTL becomes “0”, the message is discarded. Therefore, in the case where the catalog management server distributes content catalog information to a group having the number of hops “1 to 10”, it is sufficient to set the TTL value to “10” and distribute the catalog distribution message. In the case of distributing the content catalog information to the group having the number of hops “11 to 20”, it is sufficient to set the TTL value to “20” and distribute the catalog distribution message (in the case where the same catalog distribution message is received repeatedly by a node, one of the messages is discarded on the node side).

In the case of using the reproduction time (preview time) or the number of reproduction times (the number of preview times) of content data in a node as an element of the grouping condition, for example, nodes can be divided to a group of nodes in which reproduction time is “30 hours or longer” (or the number of reproduction times is “30 or more”), a group of nodes in which reproduction time is “20 hours or longer and less than 30 hours” (or the number of reproduction times is “20 or more and less than 30”), . . . . The reproduction time denotes, for example, accumulation time in which content data is reproduced within a predetermined period (for example, one month) in a node. The number of reproduction times denotes the cumulative number of reproduction times of content data in a predetermined period (for example, one month) in a node. The reproduction time or the number of reproduction times is measured in each of nodes. The catalog management node or the catalog management server distributes new content catalog information to all of nodes belonging to the group in which the reproduction time is “30 hours or longer” (in the case of distribution bythe DHT multicast, condition information indicative of the grouping condition (for example, the reproduction time is 30 hours or longer) is added to new content catalog information). After lapse of preset time (for example, 24 hours) since the distribution, the new content catalog information is distributed to nodes belonging to a group in which the reproduction time is “20 hours or longer and less than 30 hours” (in such a manner, the new content catalog information is distributed while placing priority on a group in which the reproduction time is the longest or the number of reproduction times is the largest). In the case where the catalog management server distributes the new content catalog information, information indicative of the reproduction time or the number of reproduction times is periodically collected from all of nodes.

It is desirable to measure the reproduction time or the number of reproduction time every genre of content data for the reason that the preference of the user can be known. For example, in a node, the cumulative time (reproduction cumulative time) in which content data whose genre is “animation” is reproduced within a predetermined period is 30 hours and the cumulative time in which content data whose genre is “action” is reproduced within a predetermined period is 13 hours, it is known that the user of the node likes “animation”. In this case, while placing priority on a group in which the reproduction time is the longest or the number of reproduction times is the largest in the same genre as new content data whose attribute information is registered in a new content catalog, the new content catalog information is distributed.

In the case of using the electric current passage time (current-carrying continuation time) in a node as a element of the grouping condition, for example, nodes can be divided to a group of nodes in which the current passage time is “200 hours or longer”, a group of nodes in which reproduction time is “150 hours or longer and less than 200 hours”, . . . . The current passage time denotes, for example, continuation time in which the power supply of the node is in the on state, which is measured in each of the nodes. Since each of the nodes usually participates in the overlay network 9 by power-on, the current passage time can be also said as time in which the node participates in the overlay network 9. The catalog management node or the catalog management server distributes new content catalog information to all of nodes belonging to the group in which the current passage time is “200 hours or longer” (in the case of distribution by the DHT multicast, condition information indicative of the grouping condition (for example, the current passage time is 200 hours or longer) is added to new content catalog information). After lapse of preset time (for example, 24 hours) since the distribution, the new content catalog information is distributed to nodes belonging to a group in which the current passage time is “150 hours or longer and less than 200 hours” (in such a manner, the new content catalog information is distributed while placing priority on a group in which the current passage time is the longest).

It is more effective to perform the grouping by combination of any two or more elements from the value of a predetermined digit in a node ID, a node disposing area, a service provider of connection of a node to the network 8, the number of hops to a node, reproduction time (preview time) of content data in a node or the number of reproduction times (the number of preview times), current passage time in a node, and the like.

The number of groups divided under the grouping condition is determined by the number of nodes participating in the overlay network 9, the throughput of the system S, and the distribution interval of content catalog information (that is, distribution interval since distribution of new content catalog information to all of nodes belonging to a group until distribution of the new content catalog information to nodes belonging to the next group). In the case where the maximum value of the distribution interval is set as one day (24 hours), the proper number of groups is about 10. In this case, delay of distribution to the final group behind the first group is 10 days at the maximum.

Since it is assumed that the preview time of the user fluctuates in one day more than days of week, it is preferable to set the distribution interval as one day (24 hours). For example, it is assumed that the preview frequency of content for children is high from 17:00 to about 20:00 irrespective of days of week, and it can be expected that many replicas are generated in the time zone. Consequently, there is the possibility that new content catalog information is distributed to the next group in distribution order in short time. However, there is hardly any possibility that the content is previewed in the night, so that generation of replicas can be expected only in the following day. By setting the maximum distribution interval as one day (24 hours), such fluctuations in the access frequency can be absorbed.

In the above method, after lapse of preset time since new content catalog information is distributed to all of nodes belonging to a group, the catalog management node or the catalog management server distributes the new content catalog information to nodes belonging to the next group. There is also another method. For example, after distribution of new content catalog information to nodes belonging to a group, the catalog management node or the catalog management server obtains request number information indicative of the number of requests for obtaining the new content data by the nodes (for example, the content location inquiring messages) from the root node or the cache node of the new content data. When the number of requests indicated in the request number information becomes equal to or larger than a preset reference number (specified number), the new content catalog information is distributed to the nodes belonging to the next group.

### 2. Configuration and the Like of Node

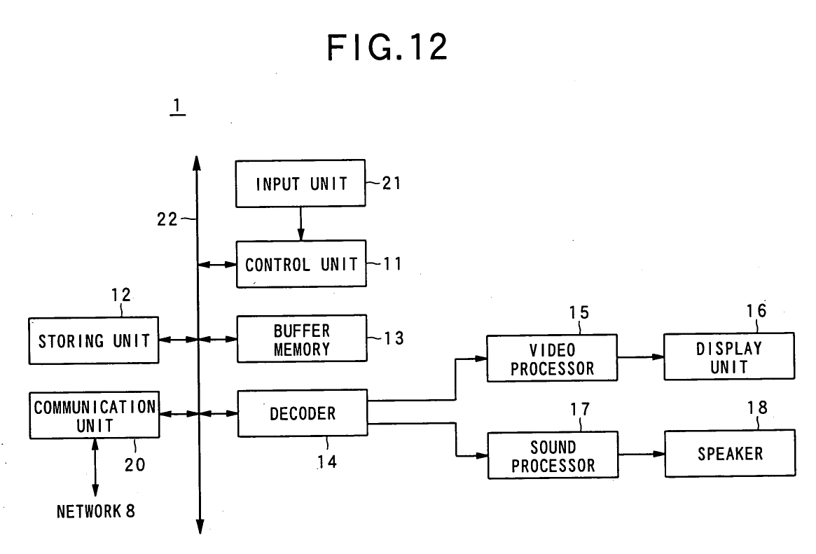

The configuration and function of a node will now be described with reference to FIG. 12.

FIG. 12 is a diagram showing an example of a schematic configuration of a node.

As shown in FIG. 12, each of the nodes has: a control unit 11 as a computer constructed by a CPU having a computing function, a work RAM, a ROM for storing various data and programs, and the like; a storing unit 12 as storing means such as an HD for storing content data, content catalog information, a routing table, various programs, and the like; a buffer memory 13 for temporarily storing the received content data; a decoder 14 for decoding (decompressing, decrypting, or the like) encoded video data (video information) and audio data (sound information) and the like included in the content data; a video processor 15 for performing a predetermined drawing process on the decoded video data and the like and outputting the resultant data as a video signal; a display unit 16 such as a CRT or a liquid crystal display for displaying a video image on the basis of the video signal output from the video processor 15; a sound processor 17 for digital-to-analog (D/A) converting the decoded audio data to an analog audio signal, amplifying the analog audio signal, and outputting the amplified signal; a speaker 18 for outputting the audio signal output from the sound processor 17 as sound waves; a communication unit 20 for performing communication control on information to/from another node via the network 8; and an input unit (such as a keyboard, a mouse, and an operation panel) 21 for receiving an instruction from the user and supplying an instruction signal according to the instruction to the control unit 11. The control unit 11, the storing unit 12, the buffer memory 13, the decoder 14, and the communication unit 20 are connected to each other via a bus 22. As nodes, a personal computer, an STB (Set Top Box), a TV receiver, and the like can be applied.

In such a configuration, the control unit 11 controls the whole by reading and executing the various programs (including a node process program of the present invention) stored in the storing unit 12 or the like by the CPU. By participating in the content distribution system S, the control unit 11 performs the process as at least one of the user node, the relay node, the root node, the cache node, and the content holding node is performed. Particularly, as the user node, the control unit 11 functions as determining means, receiving means, storing means, and the like in the present invention.

Further, the control unit 11 of the node as the catalog management node functions as the distributing means and the like of the invention by reading and executing the programs (including the distributing process program of the present invention) stored in the storing unit 12 or the like by the CPU.

In the case where obtained content data is reproduced and output via the decoder 14, the video processor 15, the display unit 16, the sound processor 17, and the speaker 18, the control unit 11 measures the reproduction time (or the number of reproduction times) of the content data, adds (integrates) the measured time to reproduction cumulative time corresponding to the genre of the content data (that is, data is classified by genre), and stores the resultant time in the storing unit 12. The reproduction cumulative time is reset (initialized), for example, every month. When the power supply is turned on, the control unit 11 starts measuring current passage time. When a power turn-off instruction is given, the control unit 11 finishes the measurement, and stores the measured current passage time to the storing unit 12.

In the storing unit 12 of each node, the AS number assigned on connection to the network 8 and the postal code (or telephone number) input by the user are stored. In the storing unit 12 of each node, the IP address or the like of the contact node is pre-stored.

In the storing unit 12 of the catalog management node, a grouping condition table specifying the grouping condition and the distribution order is stored.

The node processing program and the distributing process program may be, for example, downloaded from a predetermined server on the network 8 or recorded on a recording medium such as a CD-ROM and read via a drive of the recording medium.

Although the hardware configuration of the catalog management server is not shown, the catalog management server is constructed by a server computer including a CPU having a computing function, a work RAM, a ROM for storing various data and programs, and the like; a storing unit as storing means such as an HD for storing content catalog information, various programs, and the like; and a communication unit for performing communication control on information to/from another node via the network 8.

### 3. Operation of Content Distribution System

Next, the operation of the content distribution system S will be described.

### 3.1 Distribution by Catalog Management Node

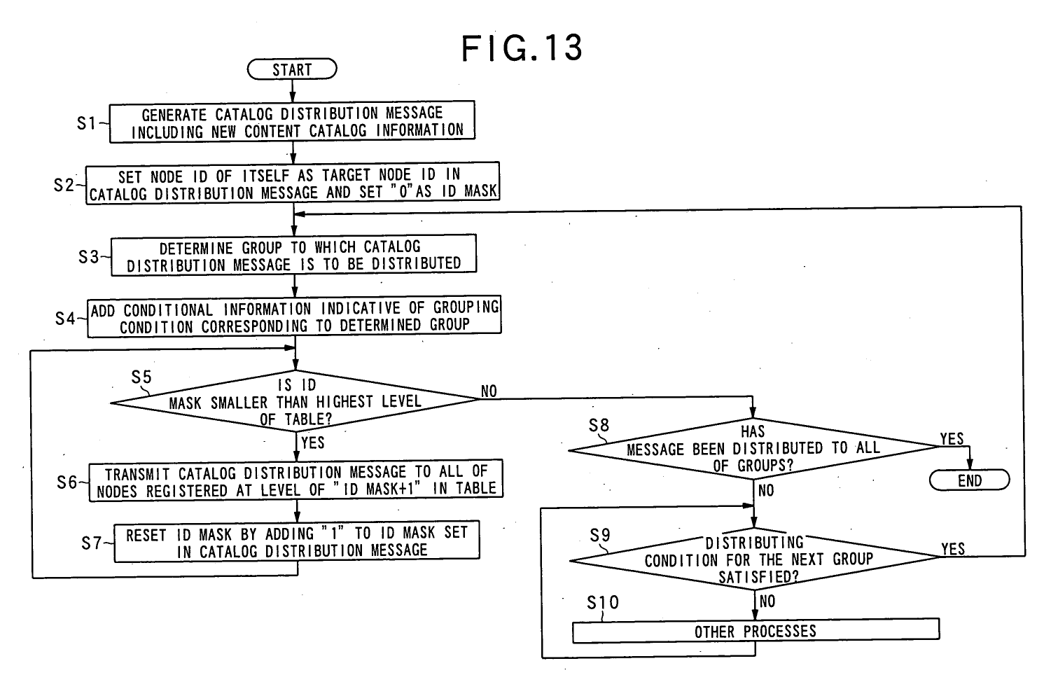

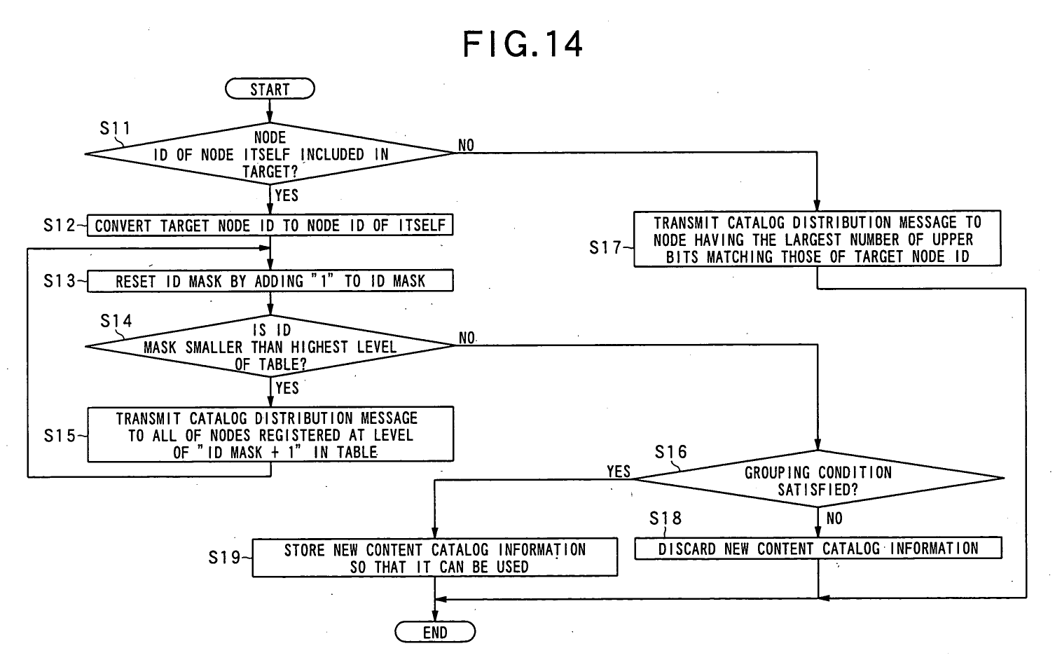

First, the case of distributing new content catalog information by the catalog management node will be described with reference to FIGS. 13 and 14.

FIG. 13 is a flowchart showing the new content catalog information distributing process in the catalog management node. FIG. 14 is a flowchart showing the new content catalog information receiving process. It is assumed that each of nodes participating in the overlay network 9 is operating (that is, the power supply is on and various settings are initialized) and waits for an instruction from the user via the input unit 21 and for receiving a message via the network 8 from another node.

The process shown in FIG. 13 is started when the node X as the catalog management node receives information indicating that new content data is entered to a certain node (including attribute information of the new content data) from, for example, a content entering server (a server which allows entrance of new content data in the content distribution system S and enters the new content data to one or more nodes). In the new content catalog information, attribute information of new content data may be described one by one, or a plurality of pieces of new content data to be entered at the same timing may be entered in a lump and their attributes may be performed. Further, a plurality of pieces of new content data which are to be entered at the same timing may be collected on the genre unit basis, and their attribute information may be written.

First, the control unit 11 of the node X generates a catalog distribution message in which the new content catalog information including attribute information of new content data obtained from the content entering server is included in the payload part (step S1). The generated catalog distribution message is temporarily stored.

The control unit 11 sets the node ID of itself, for example, “3102” as the target node ID in the header part of the generated catalog distribution message, sets “0” as the ID mask, and sets the IP address of itself as the IP address (step S2).

Subsequently, the control unit 11 determines (selects) a group to which information is to be distributed, for example, with reference to a grouping condition table stored in the storing unit 12 (step S3).

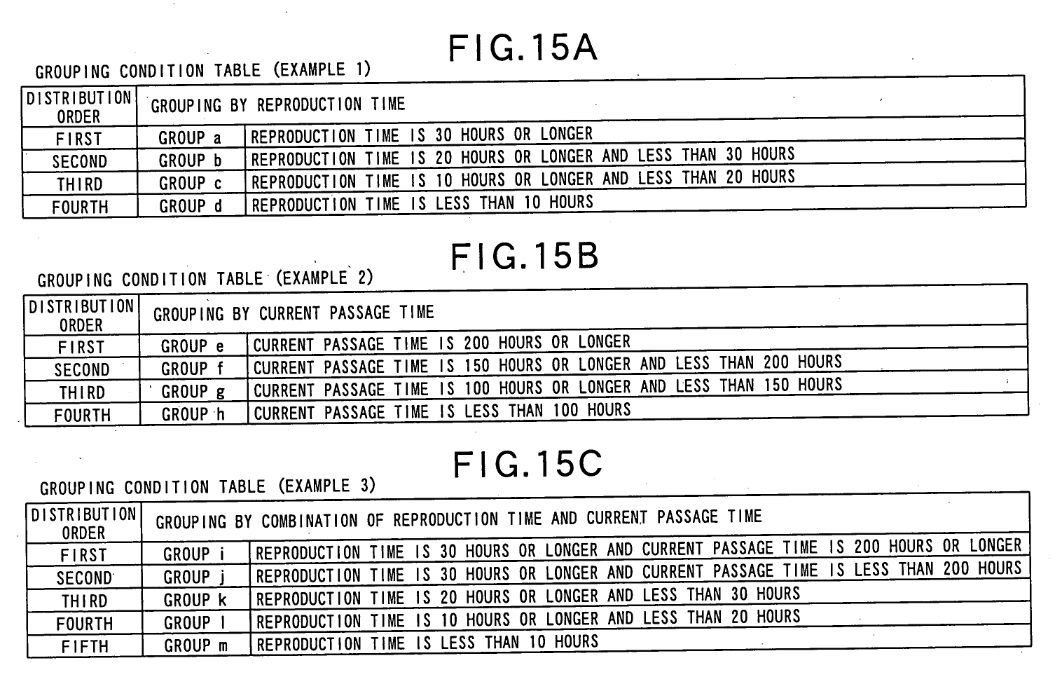

FIGS. 15A to 15C are diagrams showing examples of the content of the grouping condition table.

In the case of using the grouping condition table shown in FIG. 15A, reproduction time of content data is the element of the grouping condition. Nodes are divided into a group “a” of “30 hours or longer”, a group “b” of “20 hours or longer and less than 30 hours”, a group “c” of “10 hours or longer and less than 20 hours”, and a group “d” of “less than 10 hours”. Among the groups divided in such a manner, the group of the longest reproduction time (the group “a” of “reproduction time of 30 hours or longer”) ranking first in the distribution order is selected first (in the first loop) (the groups are sequentially selected from the longest reproduction time in the following loops (the second, third, and fourth in the distribution order)).

In the case of using the grouping condition table shown in FIG. 15B, for example, the group of the longest current passage time ranking first in the distribution order (a group “e” of “current passage time is 200 hours or longer”) is selected first (in the first loop) (the groups are sequentially selected from the longest current passage time in the following loops).

In the case of using the grouping condition table of grouping nodes by the combination of reproduction time and current passage time as shown in FIG. 15C, a group “i” of “reproduction time is 30 hours or longer and current passage time is 200 hours or longer” is selected first (in the first loop) (that is, priority is given to the nodes belonging to the group “i” (in other words, priority is given to nodes belonging to the group “a” of the longest reproduction time shown in FIG. 15A and the group “e” of the longest current passage time shown in FIG. 15B)). A group “j” ranking second in the distribution order, of “reproduction time is 30 hours or longer and the current passage time is less than 200 hours” is selected next (in the next loop). In place of selecting the group “i” from the grouping condition table shown in FIG. 15C, the group “a” may be selected from the grouping condition table shown in FIG. 15A and the group “e” may be selected from the grouping condition table shown in FIG. 15B. After that, the groups are selected in order of the group “k”, the group “l”, and the group “m” on the basis of only the reproduction time. In such a manner, by placing the highest priority on the group “i” of “reproduction time is 30 hours or longer and current passage time is 200 hours or longer”, new content data can be distributed to the users having high probability of previewing of the new content data. Consequently, the probability of increasing the number of replicas of the new content data on the overlay network 9 (that is, increasing the number of nodes storing replicas of the new content data) can be increased. Further, the new content data can be distributed to nodes whose current passage time is long and having low possibility of withdrawal from the overlay network 9. Thus, the probability that other nodes obtain the new content data (a request of obtaining the new content data is addressed) can be increased. As described above, replicas are stored efficiently in the beginning, so that accesses to the new content data are dispersed.

In the grouping condition table shown in FIG. 15C, the combination condition may be changed like the group “j” to “reproduction time of 30 hours or longer and current passage time of 150 hours or longer and less than 200 hours”, the group “k” to “reproduction time of 30 hours or longer and current passage time of 100 hours or longer and less than 150 hours”, the group “1” to “reproduction time of 30 hours or longer and current passage time of less than 100 hours”, and the group “m” to “reproduction time of 20 hours or longer and less than 30 hours and current passage time of 200 hours or longer”.

For example, a flag (“1”) is set for a group which is selected once in the process so that the group will not be selected overlappingly.

After that, the control unit 11 adds the condition information indicative of the grouping conditions (for example, reproduction time is 30 hours or longer, or reproduction time is 30 hours or longer and current passage time is 200 hours or longer) to the new content catalog information included in the payload part in the catalog distribution message (step S4).

In the case of using, for example, the grouping condition table shown in FIG. 15A, condition information indicative of the grouping condition “reproduction time of content data whose genre (the same genre as that of, for example, new content data whose attribute information is registered in the new content catalog to be distributed) is animation is 30 hours or longer” is added to the new content catalog information. In the case of using, for example, the grouping condition table shown in FIG. 15C, condition information indicative of the grouping condition “reproduction time of content data whose genre is animation is 30 hours or longer and current passage time is 200 hours or longer” is added to the new content catalog information. With the configuration, new content catalog information can be distributed to users having higher probability of desiring and using the new content catalog information.

Subsequently, the control unit 11 determines whether the set ID mask (value) is smaller than the highest level (“4” in the example of FIG. 6) of the routing table of itself or not (step S5). In the case where the ID mask is set to “0”, it is smaller than the highest level in the routing table, so that the control unit 11 determines that the ID mask is smaller than the highest level in the routing table (YES in step S5). The control unit 11 determines all of the nodes registered at the level of “the set ID mask+1” in the routing table of itself, and transmits the generated catalog distribution message to the determined nodes (step S6). By a timer, counting of distribution wait time (which is set, for example, as 24 hours) as the interval of distribution to the next group is started.

In the example of FIG. 6, the catalog distribution message is transmitted to the nodes A, B, and C registered at the level 1 as “ID mask “0”+1”.

Subsequently, the control unit 11 adds “1” to the ID mask set in the header part of the catalog distribution message, thereby resetting the ID mask (step S7), and returns to step S5.

After that, the control unit 11 similarly repeats the processes in steps S5 to S7 with respect to the ID masks “1”, “2”, and “3”. As a result, the catalog distribution message is distributed to all of the nodes registered in the routing table of the control unit 11 itself.

On the other hand, when it is determined in the step S5 that the ID mask is not smaller than the highest level in the routing table of the control unit 11 itself (in the example of FIG. 6, when the ID mask is “4”) (NO in step S5), the control unit 11 shifts to step S8.

In step S8, the control unit 11 determines whether the catalog distribution message has been distributed to all of groups specified in the grouping condition table or not. In the case where the catalog distribution message has not been distributed to all of the groups (for example, all of the four groups in the grouping condition table shown in FIG. 15A are not selected in the step S3) (NO in step S8), whether a condition of distributing the catalog distribution message to the next group is satisfied or not (for example, wait time of distribution to the next time has elapsed (counted up) or not) (step S9). When the condition of distributing the catalog distribution message to the next group is not satisfied (for example, the distribution wait time has not elapsed) (NO in step S9), the control unit 11 performs another process (step S10) and returns to step S9. In the another process in step S10, for example, a process according to various messages received from other nodes or the like is performed.

On the other hand, when the condition of distribution to the next group is satisfied (for example, the distribution wait time has elapsed) (YES in step S9), the control unit 11 returns to step S3 where the next group to which the catalog distribution message is to be distributed (for example, the group having the second longest reproduction time) is selected, and the processes in step S4 and subsequent steps are performed in a manner similar to the above.

When it is determined in the step S8 that the catalog distribution message has been distributed to all of the groups (YES in step S8), the process is finished.

In the step S3, a group to which the content data is to be distributed is determined using the content data reproduction time as the element of the grouping condition. A node belonging to a group to which content data is to be distributed may be determined using, as the element of the grouping condition, any or combination of the number of reproduction times of content data, the value of a predetermined digit (for example, the least significant digit) in a node ID, a node disposing area, a service provider of connection of a node to the network 8, current passage time in a node.

In the step S9, after distribution of new content catalog information to nodes belonging to a group, the control unit 11 may obtain request number information indicative of the number of requests for obtaining new content data by the nodes (for example, the content location inquiring message) from the root node or the cache node of the new content data and determines whether the number of requests shown in the request number information becomes equal to or larger than a preset reference number (for example, the number by which sufficient number of replicas are assured). When the number of requests becomes equal to or larger than the reference number, the control unit 11 determines that the distribution condition is satisfied, returns to the step S3, and selects the next group to which the catalog distribution message is to be distributed. With the configuration, it is expected that the number of requests for popular new content data becomes equal to or larger than the reference number relatively early, so that new content catalog information can be distributed promptly to nodes belonging to the next group.

Whether the number of requests for obtaining new content data (for example, the content location inquiry messages) becomes equal to or larger than a preset reference number or not is determined by the root node, the cache node a license server that manages the root node or the cache node, or the like. When the number of requests becomes equal to or larger than the reference number, information indicating that the number of requests becomes equal to or larger than the reference number is transmitted to the catalog management node. When the information indicating that the number of requests becomes equal to or larger than the reference number is received, the catalog management node determines in the step S9 that the distribution condition is satisfied.

It is more effective to determine in the step S9 that whether the number of requests for obtaining the new content data becomes equal to or larger than a preset reference number, determine whether the wait time of distribution to the next group has elapsed (counted up) or not and, when one of the conditions is satisfied, determine that the distribution condition is satisfied. Specifically, the method has the following advantage. It is expected that the number of requests for popular new content data becomes equal to or larger than the reference number relatively early. Consequently, when the number of requests becomes equal to or larger than the reference number, without waiting for lapse of the distribution wait time, new content catalog information can be distributed promptly to nodes belonging to the next group. On the other hand, it is expected that the number of requests for unpopular new content data does not become equal to or larger than the reference numeral. After lapse of the distribution wait time (predetermined time limit), even though the number of requests does not reach the reference number, new content catalog information can be promptly distributed to nodes belonging to the next group.

Each of the nodes receiving the catalog distribution message transmitted as described above temporarily stores the catalog distribution message and starts the processes shown in FIG. 14. The operation of the node A will be described as an example.

When the processes shown in FIG. 14 start, the control unit 11 of the node A determines whether or not the node ID of itself is included in the target node ID in the header part of the received catalog distribution message and a target specified by the ID mask (step S11).

The target denotes a node ID whose upper digits match those of the value of the ID mask in the target node ID. For example, when the ID mask is “0”, all of node IDs are included in the target. When the ID mask is “2” and the target node ID is “3102”, node IDs “31**” whose upper “two” digits are “31” (** may be any values) are included in the target.

Since the ID mask in the header part of the catalog distribution message received by the node A is “0” and the valid number of digits is not designated, the control unit 11 of the node A determines that the node ID “0132” of itself is included in the target (YES in step S11), and converts the target node ID in the header part of the catalog distribution message to the node ID “0132” of itself (step S12).

Subsequently, the control unit 11 adds “1” to the ID mask in the header part of the catalog distribution message, thereby resetting the ID mask (converting “0” to “1” (converting the ID mask indicative of a level to an ID mask indicative of the next level)) (step S13).

The control unit 11 determines whether the reset value of the ID mask is smaller than the highest level of the routing table of itself or not (step S14).

Since “1” is set in the ID mask, it is smaller than the highest level in the routing table, and the control unit 11 determines that the ID mask is smaller than the highest level of the routing table (YES in step S14). The control unit 11 determines all of nodes registered at the level of “the reset ID mask+1” in the routing table of itself (that is, since the area to which the node A belongs is divided into a plurality of areas, one node belonging to each of the divided areas is determined), transmits the generated catalog distribution message to the determined nodes (step S15), and returns to the step S13.

For example, the catalog distribution message is transmitted to the nodes A1, A2, and A3 registered at the level 2 as “ID mask “1”+1”.

After that, the control unit 11 repeats the processes in the steps S14 and S15 with respect to the ID masks “2” and “3”. By the processes, the catalog distribution message is transmitted to all of nodes registered in the routing table of the control unit 11 itself.

On the other hand, when the control unit 11 determines in the step S11 that the node ID of itself is not included in the target node ID in the header part of the received catalog distribution message and the target specified by the ID mask (NO in step S11), the control unit 11 transmits (transfers) the received catalog distribution message to a node having the largest number of upper digits matching those of the target node ID in the routing table (step S17), and finishes the process.

For example, when the ID mask is “2” and the target node ID is “3102”, it is determined that the node ID “0132” of the node A is not included in the target “31**”. The transferring process in the step S17 is a process of transferring a message using a normal DHT routing table.

On the other hand, when it is determined in the step S14 that the value of the ID mask is not smaller than the highest level of the routing table of the control unit 11 itself (NO in step S14), the control unit 11 extracts the condition information added to the new content catalog information in the payload part in the temporarily stored catalog distribution message and determines whether the grouping condition written in the condition information is satisfied or not (step S16).

For example, when it is written as the grouping condition in the condition information that “reproduction time is 30 hours or longer”, the control unit 11 determines whether the reproduction cumulative time stored in the storing unit 12 is 30 hours or longer (when no genre is designated in the grouping condition, whether the sum of reproduction cumulative times in the different genres is 30 hours or longer or not is determined, and similar operation is performed with respect to the number of reproduction times). When the reproduction cumulative time is not 30 hours or longer, the control unit 11 determines that the grouping condition is not satisfied (NO in step S16). The control unit 11 discards (deletes) the new content catalog information in the payload part in the temporarily stored catalog distribution message (step S18), and finishes the process. On the other hand, when the reproduction cumulative time is 30 hours or longer, the control unit 11 determines that the grouping condition is satisfied (YES in step S16), stores the new content catalog information in the payload part in the temporarily stored catalog distribution message in the storing unit 12 so that it can be used (step S19), and finishes the process. In such a manner, the new content catalog information is distributed only to nodes substantially satisfying the grouping condition and used (for example, the content ID of new content data in the new content catalog information is obtained, and the content location inquiring message including the content ID is transmitted to the root node as described above).

For example, when a genre is designated as the grouping condition in the condition information like “reproduction time of content data whose genre is animation is 30 hours or longer”, the control unit 11 determines whether the reproduction cumulative time corresponding to the genre “animation” is 30 hours or longer (the operation is similarly performed with respect to the number of reproduction times). When the reproduction cumulative time is not equal to 30 hours or longer (that is, the grouping condition is not satisfied), the control unit 11 discards (deletes) the new content catalog information. When the reproduction cumulative time is equal to or longer than 30 hours (that is, the grouping condition is satisfied), the new content catalog information is stored in the storing unit 12 so that it can be used.

For example, when “current passage time is 200 hours or longer” is described as the grouping condition in the condition information, the control unit 11 determines that the current passage time stored in the storing unit 12 is 200 hours or longer. When the current passage time is not 200 hours or longer (that is, the grouping condition is not satisfied), the new content catalog information is discarded (deleted). When the current passage time is 200 hours or longer (that is, the grouping condition is satisfied), the new content catalog information is stored in the storing unit 12 so that it can be used.

For example, when the value of a predetermined digit (such as the least significant digit) in a node ID is indicated as the grouping condition in the condition information, the control unit 11 determines whether or not the indicated value matches the value of the predetermined digit (such as the least significant digit) in the node ID of itself. When the values do not match (that is, the grouping condition is not satisfied), the control unit discards (deletes) the new content catalog information. When the values match (that is, the grouping condition is satisfied), the control unit 11 stores the new content catalog information in the storing unit 12 so that it can be used.

For example, when the node disposing area (for example, Minato-ward in Tokyo) is indicated as the grouping condition in the condition information, the control unit 11 determines whether the postal code or telephone number stored in the storing unit 12 corresponds to the disposing area or not. When the postal code or telephone number does not correspond to the disposing area (that is, the grouping condition is not satisfied), the control unit 11 discards (deletes) the new content catalog information. When the postal code or telephone number corresponds to the disposing area (that is, the grouping condition is satisfied), the control unit 11 stores the new content catalog information in the storing unit 12 so that it can be used.

For example, when the AS number corresponding to the service provider of connection to the network 8 is indicated as the grouping condition in the condition information, the control unit 11 determines whether or not the indicated AS number matches the AS number stored in the storing unit 12 or not. When the values do not match (that is, the grouping condition is not satisfied), the control unit discards (deletes) the new content catalog information. When the values match (that is, the grouping condition is satisfied), the control unit 11 stores the new content catalog information in the storing unit 12 so that it can be used.

For example, when the combination of reproduction time and the current passage time is indicated like “reproduction time is 30 hours or longer and the current passage time is 200 hours or longer” as the grouping condition in the condition information, the control unit 11 determines whether or not the reproduction cumulative time stored in the storing unit 12 is 30 hours or longer and determines whether the current passage time stored in the storing unit 12 is 200 hours or longer. When the condition is not satisfied (that is, the grouping condition is not satisfied), the control unit discards (deletes) the new content catalog information. When the condition is satisfied (that is, the grouping condition is satisfied), the control unit 11 stores the new content catalog information in the storing unit 12 so that it can be used.

In the case of distribution of new content catalog information by the catalog management node as described above, the new content catalog information is sequentially distributed while being transferred to all of nodes participating in the overlay network 9 by the DHT multicast, whether the grouping condition is satisfied or not is determined in each of the nodes, and whether new content catalog information can be obtained or not (used or not) is determined. Consequently, the load on a specific server such as the catalog management server can be largely reduced.

In the case of using the value of the most significant digit in a node ID as the element of the grouping condition, new content catalog information can be distributed only to nodes belonging to a group to which the information is to be distributed by using the DHT multicast. The new content catalog information distributing process in this case will be described.

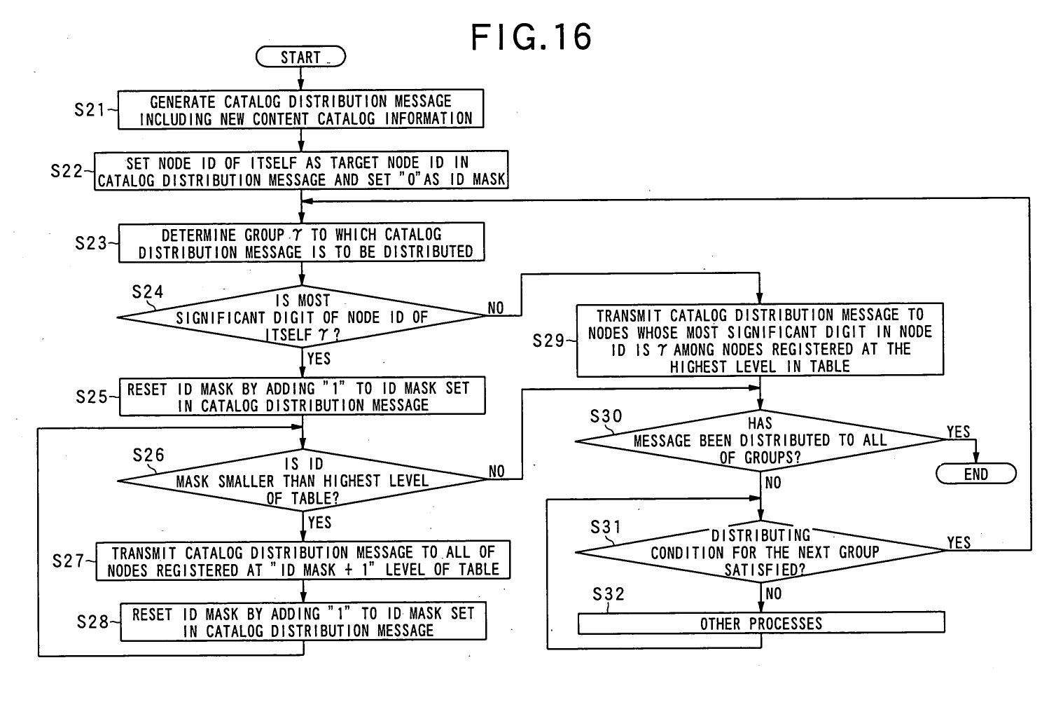

FIG. 16 is a flowchart showing the new content catalog information distributing process in the catalog management node in the case of using the value of the most significant digit in a node ID as the element of the grouping condition.

The processes in steps S21 and S22 in FIG. 16 are similar to those in the steps S1 and S2 in FIG. 13. In step S23, the control unit 11 of the catalog management node determines a group γ to which the generated catalog distribution message is to be distributed. When the node ID is expressed in hexadecimal, γ has a value from 0 to F. For convenience of explanation, the case where the node ID is expressed in four digits in quaternary will be described.

The control unit 11 determines whether the most significant digit of the node ID (for example, “3102”) of itself (the catalog management node itself) is γ (for example, “3”) or not (step S24). When the most significant digit is γ (YES in step S24), the control unit 11 adds “1” to the ID mask set in the header part in the catalog distribution message, thereby resetting the ID mask (step S25).

After that, the control unit 11 determines whether the ID mask is smaller than the highest level in the routing table of itself (“4” in the example of FIG. 6) or not (step S26). When the ID mask is smaller than the highest level in the routing table (YES in step S26), the control unit 11 determines all of nodes registered at the level “ID mask+1” (in this case “ID mask “1”+1”=2) in the routing table of itself, transmits the generated catalog distribution message to the determined nodes (step S27), and starts counting distribution wait time to the next group by a timer.

In the example of FIG. 6, the catalog distribution message is transmitted to the nodes D, E, and F registered at the level 2 as “ID mask “1”+1” but is not transmitted to the nodes A, B, and C registered at the level 1.

Subsequently, the control unit 11 adds “1” to the ID mask set in the header part in the catalog distribution message, thereby resetting the ID mask (step S28), and returns to step S26.

After that, the control unit 11 similarly repeats the processes in steps S26 to S28 on the ID masks “2” and “3”. As a result, the catalog distribution message is transmitted to all of nodes at the levels 2 to 4 registered in the routing table of itself. The processes in steps S11 to S15 in FIG. 14 are performed by each of the nodes that have received the transmitted catalog distribution message, thereby distributing the catalog distribution message to, for example, nodes belonging to the group γ(=3) (for example, nodes having node IDs “3000” to “3333” in the right upper part of FIG. 8A). In this case, the processes in steps S16 and S18 are not performed, and each of the nodes which have received the catalog distribution message stores the new content catalog information in the storing unit 12 so that it can be used.

On the other hand, when it is determined in the step S26 that the ID mask is not smaller than the highest level in the routing table of itself (in the example of FIG. 6, when the ID mask is “4”) (NO in step S26), the control unit 11 moves to step S30.

The control unit 11 determines whether the catalog distribution message has been distributed to all of the groups (γ=0 to 3) or not. When the catalog distribution message has not been distributed to all of the groups (NO in step S30), like in the step S9, the control unit 11 determines whether the distributing condition for the next group is satisfied or not (step S31). When the distributing condition for the next group is not satisfied (NO in step S31), like the step S10, the control unit 11 performs another process (step S32) and returns to step S31.

On the other hand, when the distributing condition for the next group is satisfied (YES in step S31), the control unit 11 returns to step S23 and selects the next group γ (for example, 0) to which the catalog distribution message is to be distributed.

In the case where the most significant digit in the node ID of the node itself is not γ in the step S24 (NO in step S24), the control unit 11 determines a node in which the most significant digit of the node ID is γ (for example, 0) (the node A whose node ID is “0132”) among the nodes registered at the highest level 1 in the routing table of itself, transmits the generated catalog distribution message to the determined node (step S29), moves to step S30, and performs a process similar to the above. The processes in the steps S11 to S15 in FIG. 14 are performed by each of the nodes which have received the transmitted catalog distribution message, thereby distributing the catalog distribution message to nodes belonging to the group γ(=0) (for example, nodes having the node IDs in the range of “0000” to “0333” in the left upper part in FIG. 8A). In this case as well, the processes in the steps S16 and S18 are not performed. Each of the nodes which have received the catalog distribution message stores the new content catalog information in the storing unit 12 so that it can be used. In such a manner, the remaining groups γ (for example, 1 and 2) are sequentially selected and the catalog distribution message is distributed to the nodes belonging to the selected groups.

As described above, in the case of using the value of the most significant digit in the node ID as the element of the grouping condition, the new content catalog information is distributed only to nodes belonging to the group to which the information is to be distributed. Consequently, in each of the nodes, it is unnecessary to perform the process of determining whether the grouping condition is satisfied or not as shown in the step S16, and the load on the network 8 can be reduced.

### 3.2 Distribution by Catalog Management Server

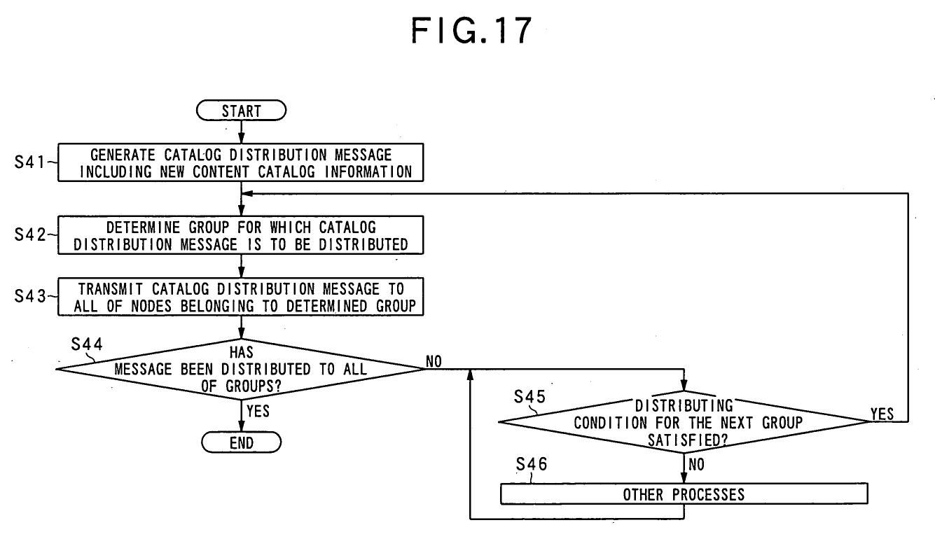

The case of distributing new content catalog information by the catalog management server will be described with reference to FIG. 17.

FIG. 17 is a flowchart showing the new content catalog information distributing process in the catalog management server.

The process shown in FIG. 17 is started, like the process shown in FIG. 13, when the catalog management server receives information indicating that new content data is entered to a certain node from, for example, a content entering server.

Like the catalog management node, the catalog management server stores a grouping condition table specifying the grouping condition and the distribution order and, further, the node IDs of nodes belonging to the groups, the IP addresses, and the like. The catalog management server also stores information of each of nodes necessary for the grouping condition (for example, a node disposing area (such as postal code and telephone number), a service provider (for example, AS number) of connection to the network 8, of the node, reproduction time or the number of reproduction times on the genre unit basis of content data in a node, current passage time in a node, and the like). Such information is obtained from a contact node (usually a plurality of contact nodes) accessed by each of the nodes when participating in the overlay network 9. Specifically, when each of the nodes accesses a contact node assigned to itself, the node transmits the node information necessary for the grouping condition to the contact node, and periodically transmits information which changes after participation in the overlay network 9 (for example, information such as reproduction time and the number of reproduction times on the genre unit basis of the content data, the current passage time in the node) to the contact node. The catalog management server periodically collects information of each of nodes necessary for the grouping condition from the contact node, and periodically performs the re-grouping. Although the catalog management server can obtain the information of each of nodes necessary for the grouping condition from each of the nodes, by involving the contact node, the load and the like on the catalog management server can be reduced.

When the process shown in FIG. 17 starts, the control unit of the catalog management server generates a catalog distribution message in which the new content catalog information including attribute information of new content data obtained from the content entering server is included in the payload part (step S41). The generated catalog distribution message is temporarily stored.

Like the process shown in FIG. 13, the control unit of the catalog management server determines (selects) a group to which information is to be distributed with reference to a stored grouping condition table (step S42). For example, in the case of using the grouping condition table shown in FIG. 15A, the group “a” ranking first in the distribution order is selected first (in the first loop). A method of determining a group by using the grouping condition table in the step S42 is similar to that in the step S3 shown in FIG. 13. In the case of considering the genre with respect to the content data reproduction time (or the number of reproduction times), for example, the grouping condition table shown in FIG. 15A has to be stored on the genre unit basis of content data. With reference to a grouping condition table corresponding to the genre (for example, animation) of the new content data, the group to which information is to be distributed is determined (selected).

Subsequently, the control unit in the catalog management server specifies the IP address or the like of a node belonging to the selected group, distributes the generated catalog distribution message to the specified node (step S43), and starts counting the distribution wait time (which is set, for example, as 24 hours) for the next group by a timer.

Like in the step S8, the control unit of the catalog management server determines whether the catalog distribution message has been distributed to all of the groups specified in the grouping condition table or not (step S44). When the catalog distribution message has not been distributed to all of the groups (NO in step S44), whether the distributing condition for the next group is satisfied or not (for example, the distribution wait time for the next group has elapsed (counted up) or not) is determined (step S45).

In the case where the distributing condition for the next group is not satisfied (for example, the distribution wait time has not been elapsed) (NO in step S45), the control unit performs another process (step S46) and returns to step S45. The process in the step S46 is similar to that in the step S10. On the other hand, when the distribution condition for the next group is satisfied (for example, the distribution wait time has elapsed) (YES in step S45), the control unit returns to the step S42 where the next group to which the catalog distribution message is to be distributed (for example, the group having the second longest reproduction time) is selected, and the processes in step S43 and the subsequent steps are performed.

When it is determined in the step S44 that the catalog distribution message has been distributed to all of the groups (YES in step S44), the process is finished.

Also in the step S45, like the step S9, after distribution of new content catalog information to nodes belonging to a group, the control unit may determine whether or not the number of requests for obtaining new content data by the nodes (for example, the content location inquiring message) becomes equal to or larger than a preset reference number. When the number of requests becomes equal to or larger than the reference number, the control unit may determine that the distribution condition is satisfied. It is more effective to determine that whether the number of requests for obtaining the new content data becomes equal to or larger than a preset reference number, determine whether the wait time of distribution to the next group has elapsed (counted up) or not and, when one of the conditions is satisfied, determine that the distribution condition is satisfied.

The catalog distribution message distributed in such a manner is received by each of the nodes, and the new content catalog information in the payload part in the catalog distribution message is stored in the storing unit 12 so that it can be used.

In the case of distribution of new content catalog information by the catalog management server, nodes belonging to a group to which the information is to be distributed is specified on the catalog management server side, and the new content catalog information is distributed only to the specified node. Consequently, in each of the nodes, it is unnecessary to perform the process of determining whether the grouping condition is satisfied or not as shown in the step S16.

As described above, in the embodiment, the new content catalog information is distributed to nodes belonging to different groups at timings which vary among the groups divided according to the grouping condition (at different timings). Thus, the device load due to concentration of accesses on the device and the network load can be minimized. Without increasing the cost of facility due to enhancement of the system for initially storing new content data, wait time of the user can be reduced.

New content catalog information is distributed preferentially to nodes belonging to groups having high possibility of using the new content catalog information (that is, groups having high possibility of requesting new content data) such as a group having longest reproduction time (or the largest number of reproduction times) and a group having the longest current passage time. Consequently, without increasing the system load, sufficient number of replicas of new content data can be stored so as to be spread to nodes at the early stage.

Although the foregoing embodiments have been described on the precondition that the overlay network 9 constructed by an algorithm using the DHT is employed, the invention is not limited to the precondition.

The present invention is not confined to the configuration listed in the foregoing embodiments, but it is easily understood that the person skilled in the art can modify such configurations into various other modes, within the scope of the present invention described in the claims.

1. A distribution apparatus for distributing content catalog information to a plurality of nodes in an information distribution system, the plurality of nodes capable of performing communication with each other via a network, and being divided into a plurality of groups in accordance with a predetermined grouping condition, and the content catalog information including attribute information of content data which can be obtained by each of the nodes,
the apparatus comprising:
storing means for storing new content catalog information including attribute information of new content data which can be newly obtained by each of the nodes; and
distributing means for distributing the new content catalog information to the nodes belonging to each of the groups at timings which vary among the groups divided according to the grouping condition.

2. The distribution apparatus according to claim 1,
wherein the distributing means adds condition information indicative of the grouping condition corresponding to a group to which the new content catalog information is to be distributed, to the new content catalog information, and distributes the resultant information.

3. The distribution apparatus according to claim 1,
wherein unique node identification information made of predetermined number of digits is assigned to each of the nodes,
the plurality of nodes are divided into the plurality of groups according to value of a predetermined digit in the node identification information, and
the distributing means distributes the new content catalog information to the nodes belonging to the different groups at timings which vary among the groups divided according to the value of the predetermined digit.

4. The distribution apparatus according to claim 1,
wherein the plurality of nodes are divided into the plurality of groups in accordance with disposing areas of the nodes, and
the distributing means distributes the new content catalog information to the nodes belonging to the different groups at timings which vary among the groups divided according to the disposing areas.

5. The distribution apparatus according to claim 1,
wherein the plurality of nodes are divided into the plurality of groups in accordance with service providers of connection to the network, of the nodes, and
the distributing means distributes the new content catalog information to the nodes belonging to the different groups at timings which vary among the groups divided according to the connection service providers.

6. The distribution apparatus according to claim 1,
wherein the plurality of nodes are divided into the plurality of groups in accordance with the number of hops from the distribution apparatus to each of the nodes, and
the distributing means distributes the new content catalog information to the nodes belonging to the different groups at timings which vary among the groups divided according to the number of hops.

7. The distribution apparatus according to claim 1,
wherein the plurality of nodes are divided into the plurality of groups in accordance with reproduction time or the number of reproduction times of content data in the nodes, and
the distributing means distributes the new content catalog information to the nodes belonging to the different groups at timings which vary among the groups divided according to the reproduction time or the number of reproduction times.

8. The distribution apparatus according to claim 7,
wherein the distributing means distributes the new content catalog information preferentially to nodes belonging to the group having the longest reproduction time or the largest number of reproduction times.

9. The distribution apparatus according to claim 7,
wherein the plurality of nodes are divided into the plurality of groups according to reproduction time or the number of reproduction times by the kind of content data in the nodes, and
the distributing means distributes the new content catalog information preferentially to nodes belonging to the group having the longest reproduction time or the largest number of reproduction times of content data of the same kind as that of the new content data.

10. The distribution apparatus according to claim 1,
wherein the plurality of nodes are divided into the plurality of groups according to electric current passage time in the nodes, and
The communication means distributes the new content catalog information to the nodes belonging to the different groups at timings which vary among the groups divided according to the current passage time.

11. The distribution apparatus according to claim 10,
wherein the distributing means distributes the new content catalog information preferentially to nodes belonging to the group having the longest current passage time.

12. The distribution apparatus according to claim 1,
wherein the plurality of nodes are divided into the plurality of groups according to reproduction time or the number of reproduction times of content data in the nodes, and divided into the plurality of groups according to the current passage time in the nodes, and
the distributing means distributes the new content catalog information preferentially to nodes belonging to the group having the longest reproduction time or the largest number of reproduction times, and belonging to the group having the longest current passage time.

13. The distribution apparatus according to claim 12,
wherein the plurality of nodes are divided into the plurality of groups according to reproduction time or the number of reproduction times by the kind of content data in the nodes, and
the distributing means distributes the new content catalog information preferentially to nodes belonging to the group having the longest reproduction time or the largest number of reproduction times of content data of the same kind as that of the new content data, and belonging to the group having the longest current passage time.

14. The distribution apparatus according to claim 1,
wherein after lapse of preset time since the new content catalog information is distributed to nodes belonging to a group, the distributing means distributes the new content catalog information to the nodes belonging to the next group.

15. The distribution apparatus according to claim 1, further comprising:
obtaining means for obtaining request number information indicative of the number of requests for obtaining the new content data from the nodes after distribution of the new content catalog information to the nodes belonging to a group,
wherein when the number of requests indicated in the request number information is equal to or larger than a preset reference number, the distributing means distributes the new content catalog information to the nodes belonging to the next group.

16. A recording medium in which a distribution processing program for making a computer function as the distribution apparatus according to claim 1 is computer-readably recorded.

17. A node for receiving new content catalog information distributed from the distribution apparatus according to claim 2, comprising:
determining means for determining whether the grouping condition indicated by condition information added to the received new content catalog information is satisfied or not; and
storing means, when it is determined that the grouping condition is satisfied, for storing the received new content catalog information so as to be able to be used.

18. A recording medium in which a node processing program for making a computer function as the node according to claim 17 is computer-readably recorded.

19. An information distributing method in an information distribution system, comprising:
a plurality of nodes being capable of performing communication with each other via a network, and being divided into a plurality of groups in accordance with a predetermined grouping condition; and
a distribution apparatus for distributing content catalog information including attribute information of content data which can be obtained by each of the nodes, to the plurality of nodes,
wherein the distribution apparatus stores new content catalog information including attribute information of new content data which can be newly obtained by each of the nodes, and distributes the new content catalog information to the nodes belonging to each of the groups at timings which vary among the groups divided according to the grouping condition, and
each of the nodes receives the new content catalog information distributed from the distribution apparatus.
